(19) United States
(12) Patent Application Publication
(10) Pub. No.: US 2022/0085984 A1
(43) Pub. Date: Mar. 17, 2022

(54) METHODS AND APPARATUS FOR RANDOMIZED ENCRYPTION, WITH AN ASSOCIATED RANDOMIZED DECRYPTION

(71) Applicant: Amir Keyvan Khandani, Kitchener (CA)

(72) Inventor: Amir Keyvan Khandani, Kitchener (CA)

(21) Appl. No.: 17/475,281

(22) Filed: Sep. 14, 2021

Related U.S. Application Data
(60) Provisional application No. 63/078,238, filed on Sep. 14, 2020.

(51) Int. Cl. H04L 9/08; H04L 9/32; H04L 9/06

(52) U.S. Cl. CPC H04L 9/0825; H04L 9/0631; H04L 9/3247; H04L 9/0869

(57) ABSTRACT

A method performed by a server includes receiving, over a first communication link, an encrypted asymmetric key from a client device; receiving, over a first communication link, an encrypted asymmetric key from a client device; receiving, over a second communication link, authentication key data from an auxiliary device associated with the client device; recovering the asymmetric key by decrypting the encrypted asymmetric key using the authentication key data; and using the decrypted asymmetric key to exchange a further encrypted message with the client device.

### CROSS-REFERENCE TO RELATED APPLICATIONS

The present application is a non-provisional filing of, and claims benefit under 35 U.S.C. § 119(e) from, pending U.S. Provisional Patent Application Ser. No. 63/078,238, titled “METHODS AND APPARATUS FOR RANDOMIZED ENCRYPTION, WITH AN ASSOCIATED RANDOMIZED DECRYPTION” and filed Sep. 14, 2020, which is incorporated herein by reference in its entirety.

### FIELD

The present disclosure relates to secure communications. In particular, the present disclosure relates to systems and methods for cryptographic key creation and usage.

### BACKGROUND

Embodiments herein relate to methods to establish and/or enhance the security of data exchange between two legitimate nodes in the presence of an eavesdropper.

Embodiments further relate to the general area of data security, methods for authentication, secure data exchange, and secure storage.

### SUMMARY

A method performed by a server includes receiving, over a first communication link, an encrypted asymmetric key from a client device; receiving, over a first communication link, an encrypted asymmetric key from a client device; receiving, over a second communication link, authentication key data from an auxiliary device associated with the client device; recovering the asymmetric key by decrypting the encrypted asymmetric key using the authentication key data; and using the decrypted asymmetric key to exchange a further encrypted message with the client device.

### BRIEF DESCRIPTION OF THE DRAWINGS

FIG. 1 illustrates method performed by a master node in generating a public/private key in accordance with at least one embodiment.

FIG. 2 illustrates operations conducted at a slave node for the purpose of encrypting a data vector in accordance with at least one embodiment.

FIG. 3 illustrates operations conducted at a master node for the purpose of decrypting a data vector in accordance with at least one embodiment.

FIG. 4 illustrates construction of a concatenated code for an embodiment using two repetition codes in accordance with at least one embodiment.

FIG. 5 illustrates an example of a generator matrix G for concatenation of a repetition code in accordance with at least one embodiment.

FIG. 6 illustrates a graphical example of capturing a binary matrix in accordance with at least one embodiment.

FIG. 7 illustrates store and forward relays within different enterprises and providing an interface between computers from different enterprises in accordance with at least one embodiment.

FIG. 8 illustrates a store and forward relays outside different enterprises and providing an interface between computers from different enterprises in accordance with at least one embodiment.

FIG. 9 illustrates sharing a key between a master node and a slave node in accordance with at least one embodiment.

FIG. 10 illustrates a method using a client's primary device and a client's secondary device to improve immunity to man-in-the-middle-attacks in two-factor authentication with a master node in accordance with at least one embodiment.

FIG. 11 illustrates an alternative method using a client's primary device and a client's secondary device to improve immunity to man-in-the-middle-attacks in two-factor authentication with a master node in accordance with at least one embodiment.

FIG. 12 illustrates a method including a secondary device using public key to establish an encryption key in accordance with at least one embodiment.

FIG. 13 illustrates an alternative method including a secondary device using public key to establish an encryption key in accordance with at least one embodiment.

FIG. 14 illustrates another method including a secondary device using public key to establish an encryption key in accordance with at least one embodiment.

FIG. 15 illustrates yet another method including a secondary device using public key to establish an encryption key in accordance with at least one embodiment.

FIG. 16 illustrates another alternative method including a secondary device using public key to establish an encryption key in accordance with at least one embodiment.

FIG. 17 illustrates yet another alternative method including a secondary device using public key to establish an encryption key in accordance with at least one embodiment.

FIG. 18 illustrates a further method including a secondary device using public key to establish an encryption key in accordance with at least one embodiment.

FIG. 19 illustrates a method where confirmation by a master node does not propagate beyond a secondary device in accordance with at least one embodiment.

FIG. 20 illustrates another method where confirmation by a master node does not propagate beyond a secondary device in accordance with at least one embodiment.

FIG. 21 illustrates a method where a public key is encrypted, and the encryption key is sent through a secondary device to a master node in accordance with at least one embodiment.

FIG. 22 illustrates another method where a public key is encrypted, and the encryption key is sent through a secondary device to a master node in accordance with at least one embodiment.

FIG. 23 illustrates an alternative method where a public key is encrypted, and the encryption key is sent through a secondary device to a master node in accordance with at least one embodiment.

FIG. 24 illustrates an embodiment where a primary or trusted device vouches for a secondary device in accordance with at least one embodiment.

FIG. 25 illustrates a method where a public key is encrypted and sent to a primary device while a seed generating the key for encrypting the public key is sent to the secondary device in accordance with at least one embodiment.

FIG. 26 illustrates a simplified method utilizing a primary device 1004 and a secondary device to avert man-in-the-middle attacks in accordance with at least one embodiment.

FIG. 27 illustrates a method utilizing a primary device, a secondary device, an authentication server, and service server to avert man-in-the-middle attacks in accordance with at least one embodiment.

FIG. 28 illustrates a method utilizing a primary device and a secondary device to avert man-in-the-middle attacks in accordance with at least one embodiment.

FIG. 29 illustrates a method utilizing a primary device and a secondary device to avert man-in-the-middle attacks, wherein a signature from each device, enables multi-factor authentication in accordance with at least one embodiment.

FIG. 30 illustrates another method utilizing a primary device and a secondary device to avert man-in-the-middle attacks, wherein a signature from each device, enables multi-factor authentication in accordance with at least one embodiment.

FIG. 31 illustrates an alternative method utilizing a primary device and a secondary device to avert man-in-the-middle attacks, wherein a signature from each device, enables multi-factor authentication in accordance with at least one embodiment.

FIG. 32 illustrates a further method utilizing a primary device and a secondary device to avert man-in-the-middle attacks, wherein a signature from each device, enables multi-factor authentication in accordance with at least one embodiment.

FIG. 33 illustrates a method and apparatus directed to reducing traffic in a video chat by forwarding audio/video of a subset of attendees in accordance with at least one embodiment.

FIG. 34 illustrates an example sending a One-Time Password (OTP) to different nodes for confirming identity in accordance with at least one embodiment.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments herein.

The apparatus and method components have been represented where appropriate by conventional symbols in the drawings, showing only those specific details that are pertinent to understanding the embodiments of the present embodiments so as not to obscure the disclosure with details that will be readily apparent to those of ordinary skill in the art having the benefit of the description herein.

### DETAILED DESCRIPTION

The present description discloses techniques to encrypt a message with the advantage that the encryption algorithm, as well as the decryption algorithm, are not deterministically known a-priori. In a master-slave configuration, randomization of encryption/decryption algorithms is performed at a master node by generating some random variables that are locally integrated into constructing an encryption scheme with public and private key components. Some embodiments of the disclosure, which rely on properties of linear block codes, in particular linear binary block codes, to construct public and private key components, offer some advantages in comparison to solutions as follows. In some methods, the structure of the underlying binary code is fundamentally randomized, in contrast to methods reported in prior solutions wherein randomization of a linear code C results in a second code C′ that is linearly equivalent to C. In other words, randomization algorithms reported in prior solutions start from a linear code C generated by a generator matrix G and through randomizing G, a code C′ is constructed with generator matrix G′ that has the same group structure as that of C, resulting in is a group isomorphism between C and C′. In prior solutions, a message x is encrypted by encoding the message using G′, and summing up the result with an error vector of weight t, which denotes the error correction capability of codes C and C′. To decrypt message x, the operations that are used to construct G′ from G are reversed, and the code C, for which an efficient decoding algorithm is known, is decoded to find the error vector and reconstruct the encrypted message x. In contrast, methods of this disclosure start from a generator matrix G that embeds the outcomes of some random experiments during construction. As a result, the error correction capability of the code generated by G is not known beforehand, and recovery of an error vector may or may not be successful. This is addressed by encrypting multiple messages and mixing the ones that resulted in a successful recovery at the master node. The result of the mixing is used as the key in a symmetric key encryption algorithm, such as Advanced Encryption Standard (AES). When none of the messages results in a successful recovery, the procedure is repeated. Unlike prior solutions that rely on a probabilistic encryption algorithm and a deterministic decryption algorithm, in methods of the present disclosure, the encryption algorithm as well as the decryption algorithm are probabilistic. The procedures used in generating public/private keys, and subsequently in executing encryption/decryption algorithms, are such that some of the random parameters involved in randomization never leave a master's device where the random parameters are generated.

Conventional encryption algorithms are mainly based on hardness of solving a complex mathematical problem, for example, discrete logarithm. As a result, in Information Theoretical sense, the encrypted data is not secret, the encrypted data is like a puzzle that has a solution, but the solution is hard to find. Traditional techniques are inherently static, in the sense that the encryption mechanism and its key do not change over time. With the continual advancement in computing power, and in particular imminent introduction of quantum computers, it is of interest to design probabilistic encryption algorithms that can withstand hacking techniques enabled using quantum computers. The present disclosure addresses this problem.

The McEliece cryptosystem consists of three algorithms: (1) a probabilistic key generation algorithm that produces a public and a private key, (2) a probabilistic encryption algorithm, and (3) a deterministic decryption algorithm. Methods of this disclosure for key generation rely on, for example: (1) a probabilistic key generation algorithm that produces a public and a private key, (2) a probabilistic encryption algorithm, and (3) a probabilistic decryption algorithm with a built-in capability to detect if decryption operation has been successful or not. In the following, methods of this disclosure will be explained by focusing on binary codes. The disclosed methods can be generalized to non-binary codes composed of alphabet {0,1, . . . D−1}, D>2, by replacing modulo 2 addition used in binary codes with modulo D addition.

All users in a McEliece deployment share a set of common security parameters n, k, t. The principle is that Alice chooses a linear code C from some family of codes for which she knows an efficient decoding algorithm. She makes C public knowledge but keeps the decoding algorithm secret. Such a decoding algorithm requires not just knowing C, in the sense of knowing its corresponding generator matrix, but requires knowledge of parameters used when specifying C in a family of linearly equivalent codes. Two binary codes are called linearly equivalent if their corresponding generator matrices G and Ĝ are related by expression \ddot{G}=SGP where S is an invertible matrix mapping a data vector x to another data \ddot{x} based on an isomorphism \hat{x}=xS and P is a permutation matrix. More specifically, the steps in McEliece cryptosystem are, for example, as follows:

Construction of Public and Private Keys
1. Alice selects a binary (n, k)—linear code C capable of correcting t errors. This choice should give rise to an efficient decoding algorithm A. Let G be a generator matrix for C.
2. Alice selects a random k×k binary non-singular matrix S.
3. Alice selects a random n×n permutation matrix P.
4. Alice computes the k×n matrix Ĝ=SGP. Note that codes constructured by generator matrices G and Ĝ are related by a group isomorphism.
5. Alice's public key is (Ĝ, t); her private key is (S, P) plus access to decoding algorithm A, which provides efficient decoding of code C generated by G, and consequently, efficient decoding of the code generated by Ĝ subject to knowing (S, P).

Message encryption. Suppose Bob wishes to send a message m to Alice whose public key is (Ĝ, t).
1. Bob encodes the message m as a binary string of length k.
2. Bob computes the vector c′=mĜ.
3. Bob generates a random n-bit vector z, an error vector, containing exactly t ones (a vector of length n and weight t).
4. Bob computes the ciphertext as c=c′+z.

Message decryption. Upon receipt of c, Alice performs the following steps to decrypt the message:
1. Alice computes the inverse of P, i.e., P⁻¹.
2. Alice computes ĉ=cP⁻¹.
3. Alice uses the decoding algorithm A to decode ĉ to \hat{m}.
4. Alice computes m=\hat{m}S⁻¹.

A primary shortcoming of a McEliece cryptosystem is that the linear code generated by the generator matrix Ĝ=SGP is linearly equivalent to the linear code generated by generator matrix G. Thus, the group structure for the code generated by matrix G is known to potential hackers and can be used to form an attack. The role of matrix S in Ĝ=SGP is to relabel code-words generated by GP to reach to code-words generated by Ĝ=SGP. This results in an isomorphism between data vector m and transformed data vector \hat{m}=mS (due to linear operation in multiplying a bit stream m by a matrix S to form the transformed data vector mS encoded by generator matrix GP). On the other hand, the role of matrix P in SGP is to shuffle bits in generated code-words. Although the structure of code-words generated by matrix Ĝ=SGP does not lend itself to a simple decoding algorithm, it is still based on a group structure similar (related by a group isomorphism) to the group structure governing code-words in linear code generated by matrix G. This property opens the door to decode linear code generated by Ĝ=SGP, which in turn enables hackers to devise attack algorithms to break the encryption. To overcome this shortcoming, McEliece crypto system is used with large block lengths, in turn increasing both decoding complexity and storage requirement. The disclosure describes one or more methods that randomize the structure of the underlying linear code in a more fundamental manner, such that the group structure of the underlying linear code may be advantageously hidden from an individual (hacker) who has access to generator matrix Ĝ=SGP.

To realize the above goal, methods of this disclosure construct the underlying linear code by concatenating a number of linear codes of much smaller lengths, which are randomly selected from a library encompassing a number of different binary codes. An embodiment is based on constructing such a library to include repetition codes of an odd length, for example, a repetition code of length 3 and a repetition code of length 5. Given a target block size N, a coin is flipped and according to the outcome, for example, a repetition code of length 3 is selected if the outcome is a head, or a repetition code of length 5 is selected if the outcome is a tail. This procedure continues until the summation of the lengths of selected repetition codes first exceeds the target block length N. Actual block length is represented by Δ≥N. The generator matrix for the resulting linear code is generated, denoted by G, and is multiplied by matrices S and P to form a new generator matrix Ĝ=SGP. To make hacking more difficult, a number, n, of vectors of length Δ, shown as {v₁, v₂, . . . vₙ}, are randomly generated, and their linear combinations are formed. Resulting vectors are included in a library L, which includes 2ⁿ code-words of the binary code generated by vectors {v₁, v₂, . . . vₙ}. This code is referred to as an auxiliary code. In an embodiment, n=2, corresponding to vectors {v₁, v₂}, and consequently, library L is composed of 4 vectors, L={0, v₁, v₂, v₁+v₂}. Corresponding to each column of generator matrix Ĝ=SGP, one element is selected from the set L with probability ¼. Selection is independent for each column of Ĝ=SGP. The resulting generator matrix is denoted as Ĝ′. This matrix, constructed at a master node A, is used as a public key for master node A in establishing a key between a master node A and a slave node B. To proceed, matrix Ĝ′, including its actual block length Δ, plus the number of errors t, which together, i.e., (Ĝ′, t, Δ), form the public key of the master node A, are transmitted to a slave node B. At a slave node B, Ĝ′ is used together with a random vector x to generate a code-word c=xĜ′. t bits positions in c=xĜ′ are randomly selected and the corresponding binary values are flipped (corresponding to t errors in code-word c) resulting in binary vector s. The slave node sends s to the master node. Note that s is composed of the summation of three vectors, a vector in the binary code generated by Ĝ=SGP, a vector in the binary code generated by code-words {v₁, v₂, . . . vₙ}, and an error vector e of weight t. For simplicity, when n=2, corresponding to generator vectors {v₁, v₂}, the binary code-words of the auxiliary code are L={0, v₁, v₂, v₁+v₂}. Master node A, first reverses the effect of permutation, shown here as multiplication of the vector received from the slave node, shown by s, by P⁻¹, the inverse of the permutation matrix. The result, denoted by ŝ=s P⁻¹, is composed of the summation of a code-word c from the binary code generated by matrix SG, plus a permuted error vector eP⁻¹ of weight t, plus one of the code-words from a permuted auxiliary code, for example, an element from the set {0, v₁P⁻¹, v₂P⁻¹, (v₁+v₂)P⁻¹}. Master node, given ŝ, aims to recover data vector xS. To proceed, master node A adds each possible code-word from the permuted auxiliary code to ŝ, resulting in four candidate vectors, for example {ŝ, ŝ+v¹P⁻¹, ŝ+v₂P⁻¹, ŝ+(v₁+v₂) P⁻¹} (assuming n=2). The binary code generated by SG has the same structure as the binary code constructed from concatenating simple component codes, which, in an embodiment, were repetition codes of an odd length. Master node A has access to its private key and thus knows the block lengths of subsequent component codes and can decode each component code by counting the total number of zeros and the total number of ones in each segment (corresponding to each component code) and deciding for the bit value (encoded in each component code) according to the larger of the two counts. The error correction capability of a repetition code of length r, where r is an odd integer is equal to [r/2]. Methods benefit from the property that, if the decision in a repetition code is wrong, the detected number of errors will be always less than the actual number of errors. For example, for a repetition code of length 3, if the number of errors is equal to 1, then a majority count decoder decides for 1 (makes a correct decision) and counts the number of bit errors to be equal to 1. On the other hand, if the number of bit errors is equal to 2, a majority count decoder makes an erroneous decision and counts the number of bit errors as 1, which is less than the actual number of bit errors. Likewise, if 3 bits are in error, then a majority count decoder makes an erroneous decision by deciding that the number of bit errors is equal to zero, which is again less than the actual number of bit errors. Thus, an erroneous decoding decision in a repetition code with an odd length results in underestimating the actual number of errors. This property is used in methods of this disclosure for a master node to decide if decoding decisions have resulted in a valid error vector or not, because the total number of detected bit errors will be equal to t if the decision is correct (i.e., code-word is correctly reconstructed), and will be less than t, otherwise. Due to randomness introduced into the code structure, the master node may not be able to detect the error pattern of weight t introduced by a slave node. To overcome such (potential) problematic cases, methods of this disclosure rely on generating multiple code-words at a slave node, which are all generated relying on the same public key obtained from the mater node, but each vector is based on an independent information vector and an independent error vector of weight t. A master node repeats the decoding procedure explained above for all such binary vectors and selects a subset for which the number of detected bit errors is equal to t. When multiple cases of success are obtained, the resulting binary vectors (upon complete recovery to be explained next) are mixed, and when the process turns out to be unsuccessful for all attempted binary vectors, the master node signals its corresponding slave node to generate more code-words, using the same public key but with newly generated information vectors and using new, independent, error vectors (each of weight t). The slave node transmits the newly generated vectors to the master node and the procedure continues until a successful result is realized.

Upon completing a successful decoding process, for example, a successful decoding includes detecting t errors or fewer, the master node reconstructs the binary vector xS, which is subsequently multiplied by S⁻¹ to find the binary vector x generated by the slave node, which is used as the key or part of the key. The master node informs the slave node of the indices of binary vectors x resulting in success. When multiple cases of success occur, the resulting binary vectors are mixed at the master node and (separately) at its corresponding slave node to derive the same final key at the master node and at its corresponding slave node.

Methods of this disclosure are presented relying on repetition codes of an odd length. Reed Muller code RM (m, r) is a binary block code of length 2^{m}, message length Σᵢ₌₀^{r}(ᵢ^{m}) and minimum distance of 2^{m-r}. If a bit is pruned from RM (m, r), the outcome will be a shortened Reed Muller code, also known as a Hamming code, denoted as H(m, r), for which the minimum distance is an odd number, i.e., 2^{m-r}−1. A repetition code of an odd length 2^{m}−1 is equivalent to H(m, 1). H(m, r) may be decomposed into a sub-code H(m, 1) and its cosets. Some embodiments of this disclosure utilize H(m, r) instead of H(m, 1). The use of H(m, r) increases the code rate versus the simpler case of using H(m, 1). A higher code-rate in turn increases key entropy. As an example, one may rely on concatenating randomly selected members from a library of binary codes composed of three members: (7,4,3)=H(3,2), (5,5,1)=H(3,1) and (3,3,1)=H(2,1) in order to form subsequent segments of a public key. Decoding of H(m, r) may be performed by relying on coset decomposition and/or trellis representation.

In conventional approaches to encryption, typically, a sophisticated encryption algorithm, for example, elliptic curve encryption, is used at the start of an encrypted session to securely communicate a symmetric encryption key among parties. The established symmetric encryption key is typically used in conjunction with an AES (Advanced Encryption Standard) encryption algorithm, such as AES256. The present disclosure typically utilizes the disclosed encryption algorithm to establish a symmetric encryption key, although application is not limited to establishing a symmetric encryption key and may be used to encrypt any form of data.

In another embodiment, the disclosed method for key generation includes a chain of linear codes (serial concatenation of component codes) with permutation operation(s) within the chain. This technique is motivated by success in channel coding in using serially concatenated codes equipped with iterative (message passing) decoding. The mathematical expression for generator matrix of such a code construction is as follows:

G=SG₁P₁G₂P₂. . . G_{q}P_{q} (Eq. 1)

where G₁, . . . , G_{g} are generator matrices, P₁, . . . , P_{q} are permutation matrices, and S is an invertible matrix.

More generally,

G=S₁G₁P₁S₂G₂P₂ . . . S_{q}G_{q}P_{q} (Eq. 2)

where G₁, . . . , G_{g} are generator matrices, P₁, . . . , P_{q} are permutation matrices, and S₁, . . . , S_{q} are invertible matrices.

An identity matrix is a special case of a permutation matrix, and an identity matrix is a special case of an invertible matrix. Thus, some of the permutation matrices P₁, . . . , P_{q} and/or invertible matrices S, . . . , S_{q} in Eq.2 may be removed (replaced by identity matrices) without loss of generality.

As described earlier, the public key of the master node is composed of matrix G provided in Eq.1 (or Eq.2), plus the code's overall block length, number of errors to be inserted, and number of encryption/decryption attempts forming one round of key exchange. Also as described earlier, component codes (corresponding to generator matrices G₁, . . . , G_{q}) are advantageously constructed by flipping a coin. In some embodiments, coin is fair and outcome of each coin flipping guides selection of a code from a library of available options, for example, selecting between two repetition codes of lengths 3 and 5. In some embodiments, a coin has a higher probability for zero as compared to one, and the outcome of each coin flipping guides selection of a bit in a (sparse) parity check matrix of a low-density parity check code. A variety of options exist for forming code components in Eq.1 and in Eq.2.

Methods of this disclosure based on Eq.1 and in Eq.2 utilize iterative decoding, for example using belief propagation, at the master node (associated with person A) to perform decoding operation required in detecting errors inserted by a slave node (associated with person B). In another embodiment, a number of bit errors is locally decided by a slave node that is using matrices provided in Eq. 1 (or Eq. 2) to encode a bit stream. In all cases, structure presented in Eq. 1 (or Eq. 2), typically, does not allow the master node to differentiate “decryption success” vs. “decryption failure” by counting the number of detected errors. Success may be detected through encoding raw data to enable error detection, for example, by adding a cyclic redundancy check to the data stream being encrypted at a slave node, typically prior to encoding by public key generator matrix and error insertion. The master node, upon decryption, verifies by checking the cyclic redundancy check whether the decryption was successful or not, and accordingly informs other node(s) involved in key establishment. In another embodiment, multiple independent streams are encrypted at once to increase the chance of successful decryption in the first round.

Man-in-the-middle attacks may cripple security of any encryption based on public/private keys. An example of a man-in-the-middle attack includes a situation where an eavesdropper or hacker inserts himself between two legitimate participants in a data transfer and pretends or fakes being both legitimate participants. An attacker, by listening to the master node, may exchange the public key of the master with the attacker's own public key and send the attacker's fraudulent public key to a slave node involved in key generation/sharing. The attacker decrypts messages sent by the slave node, plays the role of the master node in communicating to the slave node the indices of successful decryption attempts, and in turn fraudulently plays the role of the slave node in communicating with the master node, which is required in key generation/sharing. The result is that an attacker may gain unauthorized access to the key content shared between a master node and a slave node. Methods of this disclosure include embodiments addressing this shortcoming.

In one embodiment, a signature generated from the public key is sent to a secondary device belonging to the slave node through an alternative communication channel. The signature received through this alternative communication path is made available to the slave's primary device involved in key generation/sharing, where the signature is compared against a signature derived locally from the received public key. If the two signatures match, the public key is validated. Such a signature may be constructed by extracting/grouping bit values in a set of pre-identified bit positions from the public key, with or without applying some form of hashing, and sending the result to the slave node through an alternative communication link. The alternative communication link may be, for example, a short messages service (SMS) text message, sent to a secondary device, such as a cell phone belonging to or associated with the slave node, which secondary device has been registered with the relevant service provider. In another embodiment, prior to providing the received signature to the slave's primary device, the received signature is mixed with an identification number unique to the slave's secondary device, wherein the identification number has been registered with the slave's primary device. This procedure confirms relevant operations have been conducted by legitimate devices both belonging to the slave node. The primary and secondary devices belonging to the slave node may be indeed a single device supporting two different communication links between the master and the slave. For example, the primary and secondary devices may be a computer with a cellular data connection as well as a Wi-Fi data connection. In another embodiment, the public key is signed by the master node using known methods for signing a file.

Methods described above for countering man-in-the-middle attacks are described in terms of sending a signature associated with the data sent from the master node to the slave node (public key) through an alternative communication link (from the master node to the slave node). The process for confirming validity of an established key may be based on the slave node sending a signature associated with the data the slave node sends to the master node, for example encrypted binary vectors for different data values and different error patterns, through an alternative communication link from the slave node to the master node.

Several other configurations are disclosed as depicted in the drawings. In some embodiments, the public key is encrypted, and its corresponding encryption key is transmitted through an alternative link. In an embodiment, a public/private key pair is generated in a primary device associated with the slave node. The public key is encrypted and encrypted public key is transmitted to a master node through a first communication link. The key for encrypted public key is transmitted from the slave's primary device to the master node through a second communication link. As an example, the encryption key may be displayed on the screen of the primary device, and the encryption key as displayed may be scanned by a secondary device belonging to the slave node, and the slave's secondary device sends the scanned encryption key to the master node through a second link established between the slave's secondary device and the master node. The secondary device may be a cell phone, or other wired or wireless communication device, and the second link may be a communication path through cellular network, or other communication path, associated with the secondary device. In various embodiments, the message sent from the primary device to the master node includes a signature uniquely identifying the primary device and the message sent from the secondary device to the master node includes a signature uniquely identifying the secondary device. As a result, a primary and/or secondary device are authenticated at the master node, adding additional factors to the disclosed multi-factor authentication setup.

In another embodiment, the number of inserted bit errors is set such that the probability of decryption success is low, while the slave node compensates for the small probability of success by increasing the number of attempts. In this case, the chances of success for any potential man-in-the-middle attacker are low, because the attacker typically relies only on successful results and relays them to the slave, the probability of success for sharing a key between master and slave becomes negligibly small, and accordingly, rate of failure increases to the extent that a legitimate node discovers an attacker acting as a relay (man-in-the-middle).

Although the above methods for countering man-in-the-middle attacks have been described in the context of using methods of this disclosure, such as randomized encryption with associated randomized decryption, for establishing a public/private key pair, any other method for generating a public/private key pair may be utilized.

In another embodiment for generating/sharing a key between a node A (associated with person A) and a node B (associated with a person B), once node A acts as the master and node B acts as the slave, and once node B acts as the master and node A acts as the slave. This process results in sharing two keys between node A and node B. Node A and node B each locally mixes the two keys to derive the final key in this embodiment.

In some applications, an encryption key is shared between a person/node A and a person/node B, while nodes A and B may not be online at the same time. To handle such cases, an embodiment relies on intermediary nodes acting as “store and relay” units to establish back-and-forth exchanges of data between node A and node B as utilized in key exchange. In an embodiment, where a node A starts the procedure for establishing an encryption key with a node B, node A locally stores the private key. When node B is not online, node A sends the public key to a “store and relay” node C, which in turn sends the public key to node B whenever node B is online. Node B encrypts a number of messages, adds random errors to encrypted messages, and when node A is not online, node B sends the results to a “store and relay” node D, which in turn sends the results to node A whenever node A is online. Node A tries to recover encrypted messages. When node A is successful and node B is not online, node A transmits the indices of successful cases to the “store and relay” node C, which in turn sends the information to node B whenever node B is online. When node A is not successful and node B is not online, node A transmits a message indicating failure to the “store and relay” node C, which in turn sends the message to node B whenever node B is online, informing node B that the procedure for key exchange has failed and should be repeated.

Various applications for the use of an established encryption key are disclosed. Although these applications are disclosed in the context of using methods of this disclosure, such as randomized encryption with associated randomized decryption, for establishing encryption keys, any other key generation/distribution methods may be deployed in conjunction with the disclosed applications.

Applications of Encryption Keys

Video Chat Application. The disclosed methods for generating/sharing of an encryption key may be used for end-to-end encryption of video chat applications. In securing a video chat application, distributing a key among many nodes within a short period of time is of interest. The present description discloses a method to improve the speed of sharing an encryption key among multiple nodes, for example, the total time taken to share a key between multiple nodes is reduces. The embodiment includes a master node, such as a node associated with a meeting moderator/organizer, generating a random binary string to be used as the encryption key for the online video/audio meeting, which encryption key may be referred to as a meeting key. Other meeting participants, upon joining and being authenticated, receive a copy of the binary string, the meeting key, from the moderator/organizer or from some other node that access to the meeting key. This key distribution is achieved using methods of this disclosure for establishing a key between a master node and each such other participant. To speed up the process of distributing the binary string or meeting key among many participant nodes, a method is described wherein nodes that have received the binary string or meeting key may be involved in distributing the binary string or meeting key to the rest of the nodes that still have not received the binary string or meeting key. In one embodiment, the master node forms a waiting queue containing up to Mₘₐₓ nodes to be served by the master node by receiving the binary string directly from the master node and referring any remaining participating nodes to nodes that have received the binary string. In other words, the master node may delegate the task of key distribution or delivery to nodes that have received the binary string or meeting key. Each such node may itself form a queue for key delivery tasks, and if too busy, may delegate some of the key delivery tasks to another node. In this case, the node participating in key delivery may or may not have a list of other nodes that have received the binary string or meeting key. In latter case, the node may select another node at random for delegating the key delivery task. A node selected to act as a delegate in key delivery may not have received the meeting key, in which case, the delegated node may inform the node that initiated the request for acting as delegate of the delegated node's lack of meeting key, or the delegated node may reject/ignore the invitation, or simply delegate the task to some other, for example, randomly selected, node by inviting another node to act as a delegate. A variety of strategies is possible for performing/optimizing the task of delegating key delivery. Nodes that have not received the meeting key after their first request is sent to the master node may initiate a second request after a waiting time has passed.

The above disclosures of collaborative key distribution are based on a procedure that a node without a key initiates a request to some other node to receive the key. Initial requests go to a meeting organizer because, at the start, no other node has received the key. Over time, the meeting organizer refers incoming requests to nodes that have received the key. In some embodiments, meeting organizer reviews its queue and may move some of the nodes in the queue to some other node(s) that received the key and is able to distribute the key. This process reduces the length of the queue formed at the meeting organizer node, which at the start of a meeting may be a long queue. Over time, the meeting organizer node may form a list of delegates, and new nodes joining the video chat may check the list of delegate nodes and select one of these nodes to send a request for the meeting key and join that queue when the meeting organizer node is busy. Provisions for removing nodes from long queues prior to receiving service, for example, receiving the meeting key, and having a list of delegates that incoming nodes in need of receiving the meeting key may refer to instead of referring to meeting organizer, helps to balance the load of key distribution among several nodes and thereby reduce the time to complete the task of providing all nodes with the meeting key. In the above embodiments, a newly joined node refers to a node, such as a meeting organizer or a delegates, with a request for service to receive the key.

In another embodiment, a newly joined node may broadcast a request for service, and one of the nodes that has received the meeting key and is not too busy, may respond to the node that has sent the request by providing the new node with the meeting key. In the above embodiments, when a new node in need of the meeting key joins a queue and after a wait time does not receive a requested meeting key, the node may reinitiate its request. In another embodiment, a node X that joined a queue of a node Y and is waiting for service may decide, upon observing that another node, for example, node Z, is available and is likely to provide the meeting key faster than continuing to wait in the queue of node Y, the node X may decide to join the queue at node Z. In one embodiment, node X may request that node Y remove X from node Y's queue, and in another embodiment, node X does not explicitly inform node Y that node X is moving to node Z, simply completes the process with node Z and once node X has the meeting key, node X broadcasts this change to the entire set of nodes, which includes node Y, consequently node Y learns that it should remove node X from node Y's queue. In another embodiment, a node that receives the key regularly, for example, in regular time intervals, such as every 1 second, broadcasts its status as having the key to the reset of the network and stops broadcasting after a predetermined time interval, for example, after 30 seconds. Other criteria may be included to facilitate key distribution, for example, the number of key holders may be compared with the number of people in the meeting, and when the two numbers are equal, the broadcast stops. In some other embodiments, the expected number of attendees and/or the time of the meeting may be taken into account to facilitating faster key distribution.

End-to-end encryption in video chat applications has inherent shortcomings because the video content may not be available in an unencrypted form prior to reaching participants. As a result, services that are typically offered by a media server in the cloud may not be available. Recording of video chats is an example of one such application. To overcome this shortcoming, an embodiment of this disclosure relies on having a participating node. referred to as a recording node, may be dedicated to the task of recording chat sessions. The recording node may have the meeting key. In another embodiment, the recoding node may be implemented on a trusted server in the cloud. In another embodiment, such a recording node may run as an additional participant within the computer of the meeting organizer. In another embodiment, the video chat application may run on a browser and the recording facility may be integrated in the browser as an add-on.

In video chat applications, typically, a video bridge is deployed that determines which of the signals sent to the bridge should be forwarded to other participants. A parameter Num specifies the number of streams to be forwarded to all participants. In conventional systems, a decision to select the streams to be forwarded may be based on relative activity of a particular client and his/her history of activity. For example, the selection may be based on including the last Num clients who have spoken. This traditional method may suffer from several shortcomings, in particular selections may be based on ad-hoc rules, which may not be very effective/accurate. To overcome these shortcomings, methods of this disclosure may include having an organizer for the meeting who selects a primary speaker as the person who is a dominant speaker until a new primary speaker is selected. The audio/video signal of the primary speaker is forwarded, at the video bridge, to all participating nodes. In another embodiment, more than one primary speaker may be present, whose feed may be all forwarded to all participating nodes. For other non-primary participants, a button on their computer screen may facilitate a person to talk by pushing the button. The microphone and video camera of non-primary participants may by default be off until the person decides to talk and presses the “talk button” on his/her screen. Once the talk button is pressed, a microphone and video camera of that participant becomes active, and a message is sent from the computer of that particular participant to the video bridge indicating that his/her audio/video should be included in the list of signals to be forwarded. This message for forwarding may be canceled when the talk button is released, for example, once the person has completed what he/she wanted to say. In another embodiment, the push-button may only enable/disable the mic/video camera of the particular client, and a decision for selection of nodes to be forwarded is left to a distributed decision-making engine that forms the list of nodes to be forwarded based on their audio activity level without implicitly including the status of the push button. Another embodiment discloses a hybrid system that operates in an adaptive manner. For example, when the number of participants is less than a given threshold, the formation of the list of nodes to be forwarded is left to a distributed decision-making engine that forms the list based on audio activity level of different nodes. When the number of participants is above a given threshold, the status of push buttons is implicitly included, and the primary speaker(s) node(s) plus the nodes whose push-button is activated are forwarded.

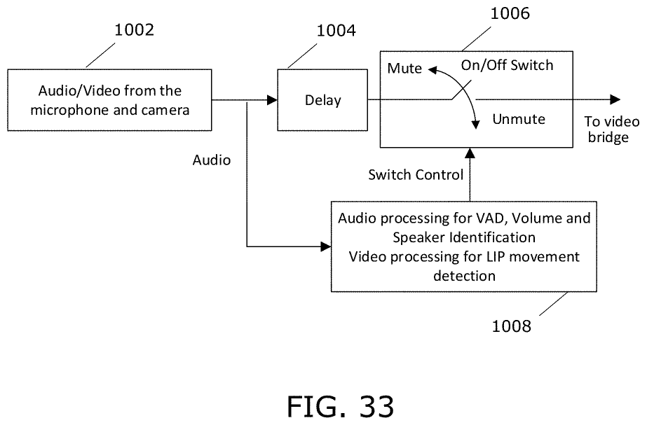

Video chat applications are either based on a “select and forward unit” that may be functioning in the cloud or are based on a “mixer” that may be functioning in the cloud. In either of these two designs, a number of participants send their video and/or audio signals to the cloud to a video bridge for setups based on “select and forward” or to a audio/video mixer for setups based on a “mixer” embodiment. To provide end-to-end encryption, setups based on select and forward are suitable because these setups facilitate encrypted incoming signals to be forwarded without decryption. In either of these two setups, keeping the bit rate as low as possible is desirable. In methods of this disclosure, this result is achieved by adding a voice activity detection (VAD) tool to clients' video chat applications, for example, software running on client's computer. See FIG. 33. In such an embodiment, the microphone and video camera of a participant is by default disabled or muted and is activated once the VAD unit detects voice activity. Activation of a video camera is optional and may be selected by each participant. Each participant may select one of two modes: a first mode wherein, upon observing a VAD signal, only the microphone is enabled or unmuted, and a second mode wherein, upon observing the VAD signal, both the microphone and the camera are enabled. To avoid harmful impact of a wrong decision concerning activation/deactivation of audio/video signals, methods of this disclosure utilize a pre-selected time window of duration T, such as T=200 msec, wherein upon observing a VAD signal, the video and/or audio are activated and remain activated for duration of at least T. In another embodiment, the sensitivity of VAD for each participant is adjusted based on the history of voice activity for that participant. In other words, for a person who has shown higher voice activity, the threshold for generating a VAD signal is reduced is desirable, which reduces the barrier for activating VAD signal. For a person who has engages in lower quantities of voice activity, the threshold for generating VAD signal is increased. In another embodiment, to reduce the rate of false voice detection, a sequence of images extracted from speaker's video are analyzed to detect movement of lips as a sign of speaking, and the result is used in combination with the VAD score to decide whether sufficient speech activity is present, and accordingly unmutes/mutes the micro-phone. In an embodiment, the information including probability of voice activity is extracted from the VAD, and lip movements are combined with a measurement of audio volume to improve accuracy. Audio volume is advantageously extracted from the sound part of the speech, for example, after removing periods of silence. Comparing the measured audio volume with its typical value for the corresponding user is utilized to detect when the signal is generated by the speaker or is noise generated by other voice in surrounding environment. To dampen the variations typical in voice volume, in an embodiment, specific parts of speech signal are detected/extracted and used in measuring the volume. For example, a range from 200 Hz to 400 Hz may be used as an indication of the volume. In another embodiment, the volume of signal and its increase in time after a segment of speech silence is measured and used to indicate speaker activity. In another embodiment, a score obtained from a speaker identification algorithm is combined with other scores obtained from voice activity detection, and volume and lip movement detection may form a composite score to determine whether the participant is speaking, or the existing sound is from other sources, such as noise, and should be removed, for example by muting the microphone.

### Secure File Sharing

Another application of a shared key is to securely store an encrypted file, while advantageously permitting subsequent access only if the owner is authenticated. To perform this task, the file owner, a node A associated with person A, locally generates a random key (KF) for encrypting a file F at the file owner's computing device or computer. The file owner's computing device generates a second key (KAF) by mixing the owner's password with the owner's name, for example, login credential, and with a file identification number, for example, an unencrypted random number appended to the file header after the body of the file is encrypted. The file identification number may be a file identifier generated by an online storage service, for example, Google drive. Mixing may be performed using a cryptographic hash function, such as SHA-256. The file is locally encrypted using KF, advantageously using the secure portion of a computer used by the file owner, for example, a computer dedicated to securely perform computations. This secure computational engine is similar to the environment created by a smart card and is available in new generations of windows and Apple/MAC computers. Advantageously, KF is not stored on the owner's (person A's) computer, likewise, KAF is not stored on the owner's (person A's) computer. The owner's (person A) computer computes SAF=KF⊕KAF and sends SAF to the server. The connection is secured using a key KT1, advantageously generated using methods described in this disclosure. The advantage of using KF to encrypt the file is that the key is random, for example, the key has an entropy equal to its length, while a key that is generated from a password, for example, KAF, is inherently less random, for example, the key has an entropy less than its length). By storing SAF=KF⊕KAF on a server, because, typically, a server has a security level higher than a typical personal computer, such as the computer of person A, the chances that the key is compromised or hacked are reduced. Unlike KAF, SAF, which is stored on a server, has an entropy equal to its length, making the process more difficult for an unauthorized person/computer to guess SAF. Another advantage is that future access to the file F in an unencrypted form requires that the owner authenticates with the server, reducing the chances of unauthorized access. In the future, to access the file F, for example to locally decrypt the file F, the file owner first authenticates with the server. Upon successful authentication, the server and the file owner share a key KT2, advantageously using methods described in this disclosure, to be used to securely transmit SAF back to the file owner's computer. Subsequently, (1) SAF is retrieved from the server, for example, becomes accessible within the original file owner's computer (person A's computer), (2) KAF is regenerated locally, within person A's computer, from the owner's password, unencrypted file identification number, and owner's login-name used in generating KAF, and the outcome is used within the owner's computer to compute KF=KAF|SAF=KAF⊕KF⊕KAF=KF, which is used to decrypt the file. In summary, KF is not stored on the owner's computer, and for each file F belonging to person A's computer, an auxiliary key SAF is stored on a server. SAF is not stored on the owner's computer. SAF can be considered as a signature that enables the person A's computer to decrypt a file F.

Another disclosure relates to sharing a file, for example, originally owned by a person A's computer, that is encrypted using the method described above with another person's computer, for example, person B's computer. To share a file originally encrypted by person A's computer with person B's computer, a key KAB is first established between A and B, advantageously using methods described in this disclosure. The identification number of file F, the file to be shared, is made available to person B's computer in an unencrypted form. Person B's computer generates a key KBF by mixing Person B's password and Person B's login name with the unencrypted identification number of the file F. Person A's computer and person B's computer share a key KAB, advantageously generated/shared using methods described this disclosure. Person A's computer regenerates KAF from person A's password, unencrypted file identification number, and Person A's login name. Person A's computer computes KA=KAF⊕KAB and sends KA to a server, and person B's computer computes KB=KBF⊕KAB and sends KB to the server. The server computes SAF⊕KA⊕KB=KF⊕KAF⊕KAF⊕KAB⊕KBF⊕KAB=KF⊕KBF. The resulting binary vector, KFEBKBF, denoted as SBF, is stored at the server. Subsequently, when person B's computer attempts to decrypt the file F, the server sends SBF t to person B's computer, which regenerates KBF and computes SBF=KF⊕KBF⊕KBF=KF, thereby enabling person B's computer to locally, within person B's computer, decrypt a file F that is shared between person A's computer and person B's computer.

### Two-factor Authentication

Another embodiment of the present disclosure relates to authentication of an individual/device prior to granting access to a service S, for example, receiving a signature vector SAF required in decrypting a file F on a person A's computer, granting access to a shared file owned by a person A's computer with a person B's computer, or admitting a person C's device into an online video chat. Hereafter, this operation is called access to service S. Prior solutions in authentication, such as Duo two-factor authentication, rely on pushing a message that requires confirmation or rejection within a set time window by a server into a computing device, such as a smart device, belonging to a person A and registered on the server in person A's account associated with service S, whenever the server detects that person A's device is attempting to access service S. This process involves installing a monitoring application on the computing device to monitor/authorize/reject such an access request. The login procedure is allowed to continue only if person A indicates via the application installed on his/her relevant computing device that the access attempt is indeed legitimate, in other words, initiated by person A on person A's device. Confirmation/rejection of access request may be a simple selection of an option displayed on the device's screen without requiring that person A authenticates on the device, or the process may require some form of authentication, for example using a bio-metric signature, of person A on person A's device to access the screen of the application related to confirmation/rejection act and facilitating person A to confirm/reject the corresponding access request. One advantage of such a technique is the ability to detect an unauthorized attempt for access and rejecting any unauthorized attempts. A person's device may fall into the hands of an individual with mischievous intensions, which person is referred to as a hacker, who can potentially bypass the security barrier of the computing device and gain access to the monitoring application even when a bio-metric or other signature is required for confirmation/rejection of an access request. A shortcoming of such a technique is that the confirmation/rejection message/request may be potentially high-jacked on the way to person A's device, and a fraudulent confirmation response may be generated and sent to the server, making possible for individuals with mischievous intensions to potentially bypass two-factor authentication.

The present description discloses a technique to overcome the above shortcomings of two-factor authentication. This technique is based on starting a two-factor confirmation procedure from a first device, such as a personal communication device including, for example a smart phone or other portable personal computing device, which deice has been registered using at least one unique identification factor, referred to as a device identifier, such as a phone number associated with a phone, an IMEI (International Mobile Equipment Identity) number associated with a phone, serial number associated with smart phone or a chip within the smart device, for example, a Bluetooth chip serial number. To authorize an access request, a user owning an account with a service provider, starts the authentication application, which generates an authentication token, including the device's identifier, and forward the authentication token to service provider. In an embodiment, a user advantageously first authenticates on the user's relevant device, for example, using a PIN, a password, or some form of bio-metric signature. The disclosed embodiment is described in the context of two-factor or multi-factor authentication, wherein an individual aims to access a service using a device X having a device identifier IX and uses a second device Y having a device identifier IY to confirm the eligibility of the service request. To close the loop, in another embodiment, an identifier, for example, a bar code or a numerical value, which identifier is specifically related to the service request at hand, may be sent by the authentication server to the user's primary device, where the identifier is displayed on the primary device's screen, and entered into a secondary device, where the identifier is mixed with one or more identifiers associated with the secondary device, and the result is sent to the authentication server. The process may utilize more than two devices or a single device X confirming the access request using device identifier IX.

As an example for the application of the disclosed technique, an individual, trying to join an online video chat, sends an authorization token to a meeting organizer/initiator by selecting an invitation link that advantageously includes the individual's device's identifier and/or individual's login name, for example, email address, sent by the meeting organizer/initiator. To improve security, this process may be requested by a meeting organizer/initiator by displaying a message requesting confirmation for accessing the service on a person's primary device PD used for accessing the service. and the time for the individual to send the authorization token using a second device SD is measured to make sure the delay in reacting to a confirmation request is within an acceptable threshold. To improve security, an embodiment of this description includes entering a passcode on a keyboard displayed on device's screen, or verifying the identity of the claimant, by relying on a bio-metric of choice, prior to sending an authentication token from device to server.

In situations, such as video chat, where a large number of participants access a service, confirmation of identities of a large number of individuals may be challenging. To address this issue, embodiments of this description utilize a web portal where individuals, once registered, may confirm their identity by entering their passwords, and the web portal show the password related to a particular event, for example, a video chat. The web portal may also be set to send automatic emails to participants related to a particular event, for example, a video chat, a few minutes prior to the event, including the meeting link and meeting password. In some embodiments, individuals participating in meetings may be advantageously required to vouch for the authenticity of other participants. For example, upon completion of a meeting, the web portal displays a list of participants and asks if any participant does not vouch for the identity of others, meaning that the participant does not confirm that the presented list is a true representation of individuals who attended the meeting. In this manner, over time, the web portal gathers data confirming identities, and generates an authenticity score for each individual. For example, the authenticity score for a person X may be a number of different individuals or persons who, over time, have confirmed the identity of person X. Relying on the authenticity score, the web portal may ease the authentication procedure to improve user convenience. For example, if the authenticity score is above a threshold TA, the web portal may bypass the password entry and authenticate a person with high authenticity score by simply relying on the identifying signature of the machine used by the individual.

### Preventing Man-in-the-Middle Attacks

Methods for key exchange are prone to man-in-the-middle attacks. Not disclosing a public key to individuals outside the circle of trust is desirable because access to a public key facilitates brute force attacks that over time may result in extracting useful information about data being encrypted. Methods of this disclosure address these issues, while providing for two-factor authentication. In the disclosed embodiments, a master node A generates a public key generator matrix G as well as a random number S to be used as the seed for a random number generator. Master node A initiates the random number generator using the seed S and generates a binary vector Mₐ of the same binary length as that of generator matrix G. Generator matrix G is bit-by-bit masked, for example, XORed, with Mₐ and the result, G⊕Mₐ, is sent to a slave node B. In addition, master node A copies a selected set of bits from the original generator matrix G, for example bits on a diagonal of matrix G, forms a vector u from these bits, and computes the hash of vector u with a binary value serving as a signature that is known to the slave node B, for example, the ID, for example, login-name, of the client. The result of this hash, referred to as Hₐ, together with S are transmitted by the master node to a second device, for example a cell phone, belonging to the client. The values, S, Hₐ, are mixed with a unique identifying signature of the second device, for example, the Bluetooth address within the cell phone, generating a binary vector I_{c} that serves to prove the authenticity of the cell phone. I_{c}, S, Hₐ are sent, for example using Bluetooth connectivity, from the second device to the client primary device, the slave node, that is involved in establishing an encryption key with the master node. The slave node, upon receiving S generates the random bits used in Mₐ, reconstructs Mₐ and uses the result together with G⊕Mₐ that was received earlier to recover G=G⊕Mₐ⊕Mₐ. The slave node extracts the bits of G used in construction of Hₐ, use these bits to reconstruct Hₐ, and compares the result with the copy received from the cell phone. This process proves the authenticity of the public key, where a match confirms that matrix G is genuine. In one embodiment, the unique identifying signature of the second device is previously registered at the primary device, and the authenticity of the second device is verified by generating I_{c} and comparing the result with the copy received from the secondary device. In another embodiment, the unique identifying signature of the secondary device is mixed with a unique identifying signature of the primary device from within primary device, and the result is sent by the primary device to the server. In this case, both devices used by a client are advantageously first registered at the server and recorded in the relevant database. This process proves the authenticity of both devices.

In another embodiment, instead of extracting bits from a public key generator matrix, a master node divides the generator matrix into several pieces, mixed the pieces, and send the result to a client's secondary device. This process may optionally include mixing with a binary value serving as a signature that is known to the slave node B, for example, the ID or login-name of the client.

Above embodiments are described wherein a loop is formed starting from the master node, to client's secondary device, and from client's secondary device to client's primary device. In some embodiments, the loop is closed by mixing the signature that the client's primary device received from a client's secondary device, with a signature identifying the client's primary device, for example, a serial number or Bluetooth address, and sending the result to the master node. The loop may be traversed in reverse order, wherein the client's secondary device, instead of being recipient of data sent by master node in the first hop of the information transfer, may send information to the master node as the hop that concludes the verification loop. In other words, to verify the authenticity of the public key as well as authenticity of client's primary and secondary devices, the client's primary device computes a signature from the public key, mixes the signature with an identification number specifying the client's primary device as registered at the master node, and the result is sent by the client's primary device to the client's secondary device, where the signature is mixed with an identification number specifying the client's secondary device as registered at the master node, and transmitted by the client's secondary device to the master node. The master node reconstructs the composite signature relying on parameters that are local to the master node and compares the outcome with what was received through the verification loop.

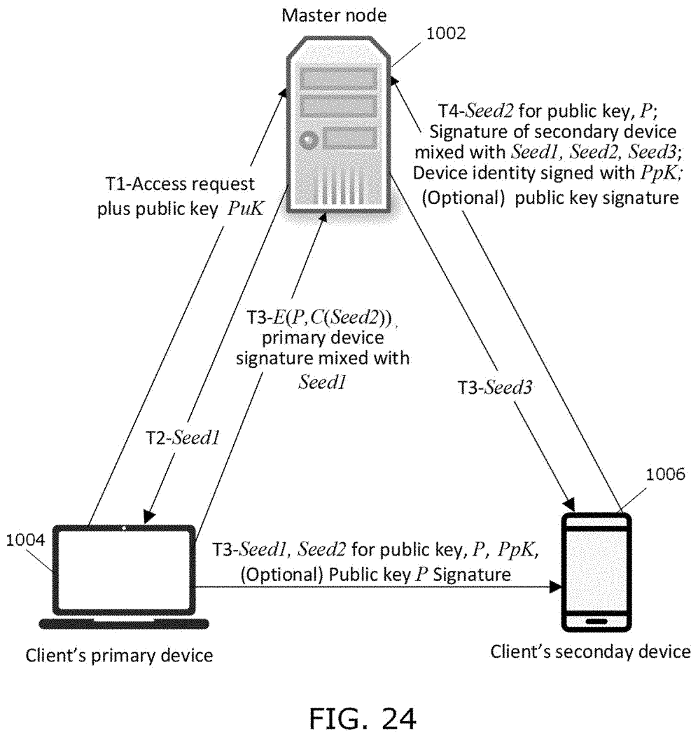

Although some embodiments for two-factor authentication and verification in this disclosure are described in conjunction with the disclosed technique for key generation, the same techniques may be used together with conventional methods for sharing keys. As an example, a method commonly used for authentication relies on a claimant signature produced using the claimant's private key, which may be verified using the claimant's public key available at the node that aims to verify the authenticity of the signature. In conventional techniques, the public/private key pair are presumed to be generated ahead of time, and the public keys are made available publicly or made available to nodes that may want to verify authenticity of the key owner. A complication is that such signing key pairs should be generated by certified agencies. Another complication is that private key, if compromised, create a chain of events for key revocation. In some applications, registering a new device through a device that is already registered with a server is desirable. In a sense the device that is already registered and demonstrates convincing evidence for its authenticity may subsequently vouch for another device. An embodiment of this disclosure is based on generating a public/private signing key pair at a trusted device, and, once the trusted device has successfully authenticated with the server, the trusted device sends one of the two keys to the server and sends the second key to a second device as part of mechanism to vouch for new device in its registration with server. The new device uses the key received from the trusted device to sign a signature specifying the new device, for example, the new device's Bluetooth address, and send the result to the server, advantageously through a secure channel. The server, having access to key sent by trusted device, may verify authenticity of signature and thereby authenticity of the new device's signature. FIG. 24 represents such an embodiment, wherein a primary device vouches for a secondary device. FIG. 24 includes aspects of other embodiments of this disclosure.

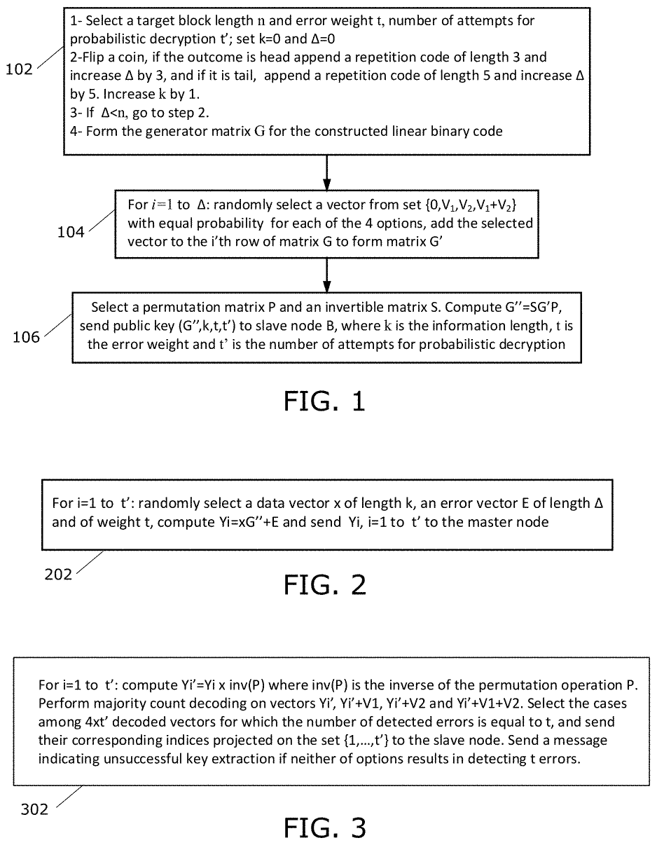

FIG. 1 depicts a method performed by a master node in generating a public/private key. Construction and parameters are selected according to embodiments compromising repetition codes of length 3 and 5, with two generators V₁ and V₁ used to expand the code generated by G to a code generated by G′, which includes the code itself as a sub-code and three cosets with coset leaders V₁, V₂ and V₁+V₂. As shown in FIG. 1 at 102, [1] A target block length, n, an error weight, t, number of attempts for probabilistic decryption, t′, are selected. The parameters are set such that k=0 and Δ=0. [2] A coin is flipped. If the outcome is heads, a repetition code of length 3 is appended and Δ is increased by 3. If the outcome is tails, a repetition code of length 5 is appended and Δ is increased by 5. k is increased by 1. [3] if Δ<n, go to [2]. [4] The generator matrix G is formed for the constructed linear binary code. For i=1 to Δ, a vector is randomly selected from the set {0, V₁, V₂, V₁+V₂} with equal probability for each of the four options and the selected vector is added to the i^{th} row of matrix G to form matrix G′ at 104. At 106, permutation matrix P and an invertible matrix S are selected. G″=SG′P is computed, public key (G″, k, t, t′) is sent to slave node B, where k is the information length, t is the error weight, and t′ is the number of attempts for probabilistic decryption.

FIG. 2 depicts operations conducted 202 at a slave node for the purpose of encrypting a data vector x. For i=1 to t′, a vector of length k and an error vector E of length Δ and of weight t are randomly selected. Yi=xG″+E is computed, and Yi, i=1 to t′ are sent to the master node.

FIG. 3 depicts operations conducted 302 at the master node for the purpose of decrypting a data vector x. For i=1 to t′, Yi′=Yi×inv(P) where inv(P) is the inverse of the permutation operation P. Majority count decoding is performed on vectors Yi′, Yi+V₁, Yi′+V₂, Yi′+V₁+V₂. The cases among 4×t′ decoded vectors for which the number of detected errors is equal to t are selected, and their corresponding indices projected on the set {1, . . . , t′} is sent to the slave node. A message indicating unsuccessful key extraction is sent if neither option results in detecting t errors. The projection on the set {1, . . . , t′} indicates the index i from the set {1, . . . , t′}, if any of vectors Yi′, Yi+V₁, Yi′+V₂, Yi′+V₁+V₂ result in detecting t errors. If such an index is not found, the decryption process was unsuccessful, in which case, the master node informs the slave node, with no need to resend the public key, to repeat the encryption operations depicted in FIG. 2.

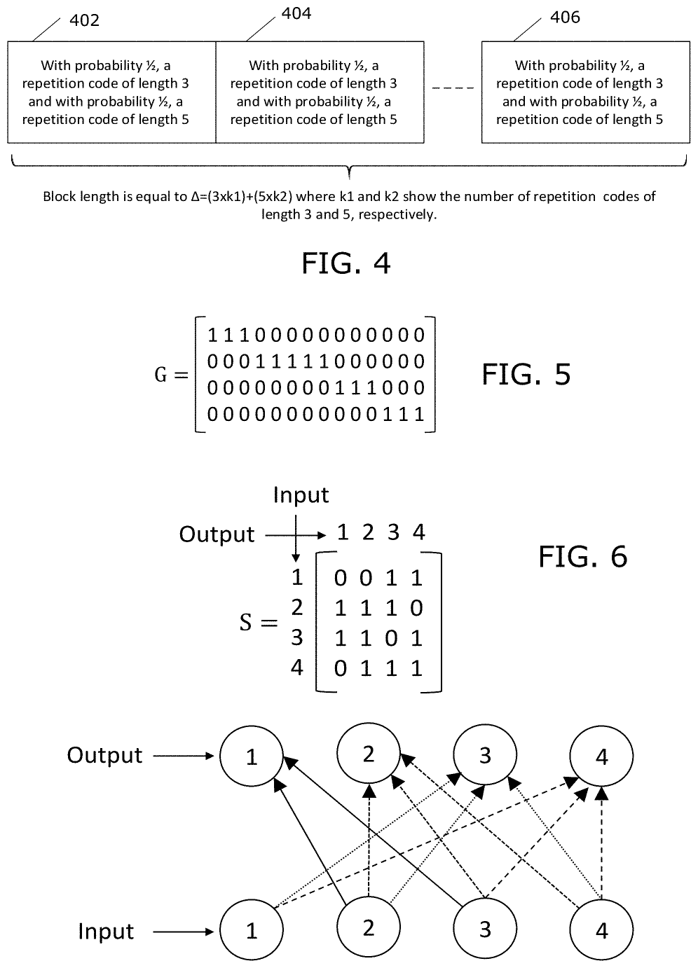

FIG. 4 depicts construction of a concatenated code 402, 404, 406 for an embodiment using two repetition codes of lengths 3 and 5, respectively, selected with equal probabilities. The block length Δ=(3×k1)+(5×k2), where k1 and k2 show the number of repetition codes of length 3 and 5, respectively.

FIG. 5 illustrates an example of a generator matrix G for concatenation of a repetition code of length 3, with a repetition code of length 5, then with a repetition code of length 3, and then again with a repetition code of length 3.

FIG. 6 depicts an example of capturing a binary matrix in a graphical representation. In particular, to enable iterative decoding at the master node, there is a need to capture the operation due to matrix S, and/or its inverse S⁻¹, in the form of a graphical representation. FIG. 6 depicts an example for a matrix S including inputs 1 through 4 and outputs 1 through 4.

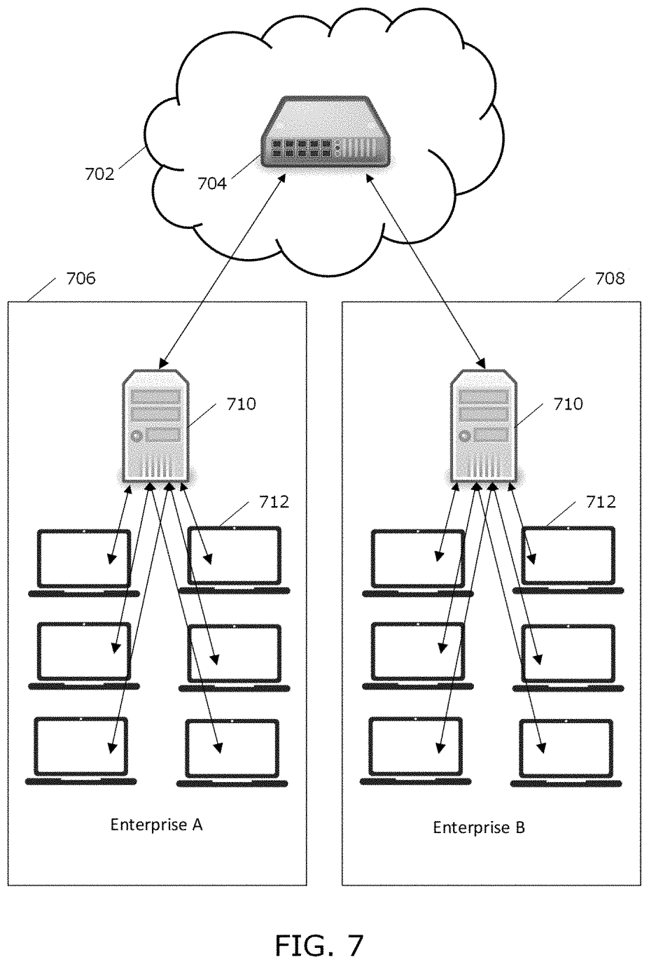

FIG. 7 depicts store and forward relays 710 providing an interface between computers 712 within an Enterprise A 706 and computers within an Enterprise B 708, wherein the flow of information from Enterprise A 706 to Enterprise B 708 is relayed through a store-and-forward-relay 710 for Enterprise B 708, and the flow of information from Enterprise B to Enterprise A is relayed through store-and-forward relay 710 for Enterprise A 706. The store and forward relays 710 are operably coupled through communication paths to one or more servers 704 operating, for example, within the cloud 702.

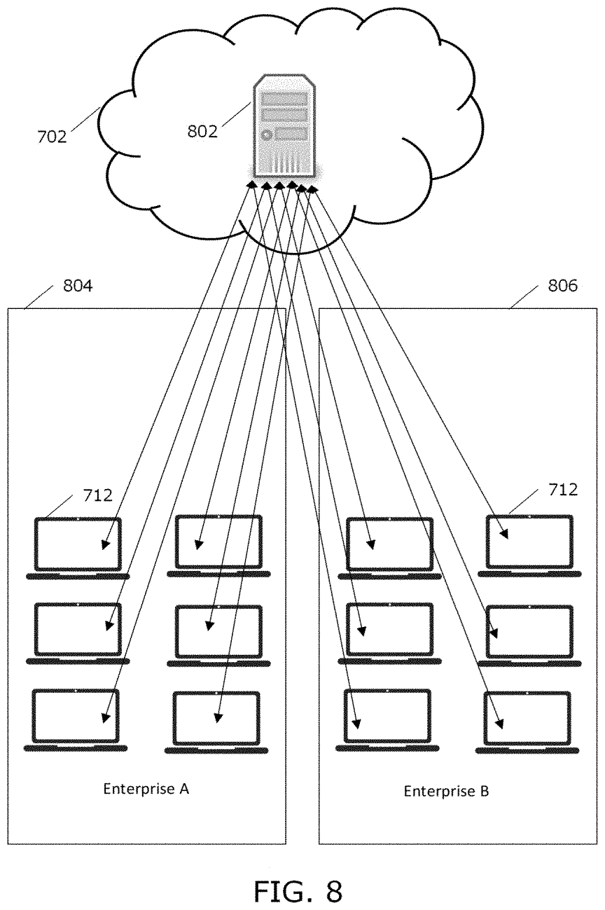

FIG. 8 depicts a store and forward relay 802 providing an interface between computers 712 within an Enterprise A 804 and computers 712 within an Enterprise B 806, wherein the flow of information from Enterprise A 804 to Enterprise B 806 and flow of information from Enterprise B 806 to Enterprise A 804 are both relayed through a common (shared) store and forward relay 802, which may be operating, for example, within the cloud 702.

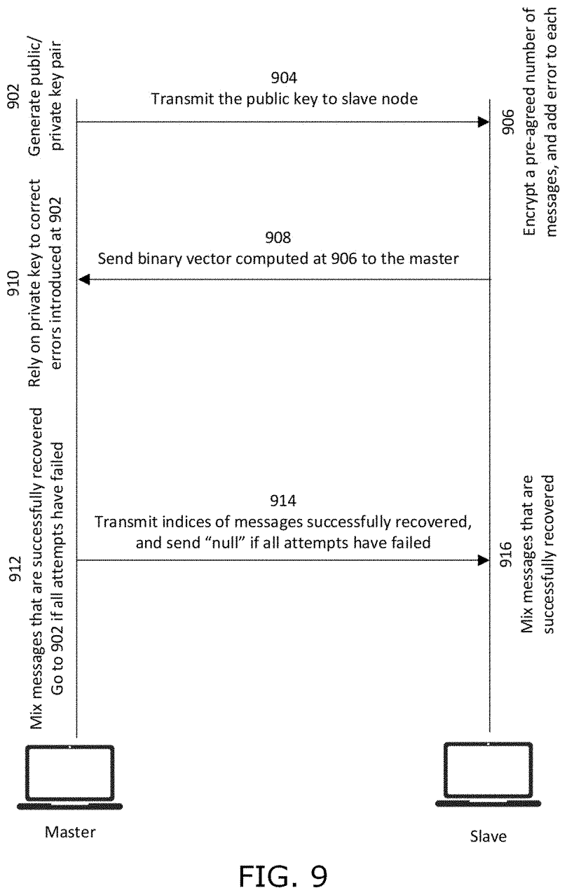

FIG. 9 depicts sharing a key between a master node and a slave node in accordance with an embodiment. A public/private key pair is generated 902. The public key is transmitted 904 to slave node. A pre-agreed upon number of messages are encrypted, and an error is added to each 906. The binary vector computed at 906 is sent 908 to the master. The private key is relied on to correct errors 910 introduced at 906. Messages that are successfully recovered are mixed 912. If all attempts have failed, go to 902. Indices of messages successfully recovered are transmitted 914. A null is transmitted if all attempts have failed. Messages that are successfully recovered are mixed 916.

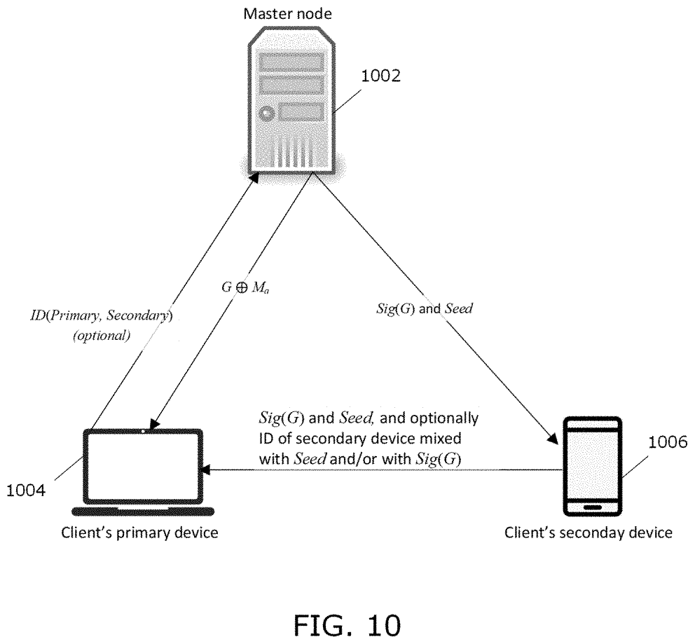

FIG. 10 depicts an embodiment for improving immunity to man-in-the-middle-attacks, while hiding public key, verifying authenticity of public key, and verifying authenticity of a client's primary device 1004 and a client's secondary device 1006 in a two-factor authentication with a master node 1002. A random number Seed is generated by the master node 1002. Seed is used as a seed in a random number generator, generating Mₐ. G⊕Mₐ is computed by the master node 1002. G⊕Mₐ is sent to client's primary device 1004. G is divided into segments and mixed to obtain a signature for G, referred to as Sig(G). Sig(G) and Seed are sent by the master node 1002 to the client's secondary device 1006. Sig(G) and Seed, and optionally an ID of the secondary device 1006 are mixed with Seed and/or with Sig(G), are sent from the the client's secondary device 1006 to the the client's primary device 1004. The mixture is referred to as ID(Secondary). Seed is used by client's primary device 1004 as a seed in the same random number generator used by the master node 100 to generate Mₐ. Mₐ⊕Mₐ⊕G=G is computed by the client's primary device 1004. The client's primary device 1004 computes Sig(G) and compares with Sig(G) received from the client's secondary device 1006 to verify authenticity of G. Optionally, the client's primary device 1004 computes ID(Secondary) and compares with ID(Secondary) received from the client's secondary device 1006 to verify authenticity of the secondary device 1006 at the primary device 1004. Optionally, the client's primary device 1004 mixes ID(Secondary) with an ID of the primary device 1004 and sends the result, referred to as ID(Primary, Secondary) to the master node 1002. The master node 1002 regenerates ID(Primary, Secondary), compares the two copies, and verifies if both the primary device 1004 and the secondary device 1006 are authentic. Optionally, the master node 1002, upon identifying the client, adds the credentials of the primary device 1004 related to the particular client registered at the master node 1002 to its firewall setting to facilitate future access.

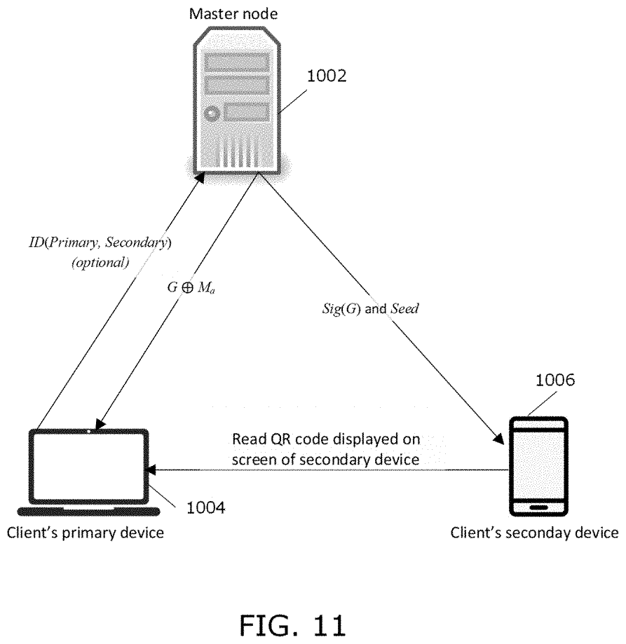

FIG. 11 depicts another embodiment for improving immunity to man-in-the-middle-attacks, while hiding public key, verifying authenticity of a client's primary device 1004 and a client's secondary device 1006 in a two-factor authentication with a master node 1002. A random number Seed is generated by the master node 1002. Seed is used as a seed in a random number generator, generating Mₐ. G⊕Mₐ is computed by the master node 1002. G⊕Mₐ is sent to client's primary device 1004. G is divided into segments and mixed to obtain a signature for G, referred to as Sig(G). Sig(G) and Seed are sent by the master node 1002 to the client's secondary device 1006. The data of Sig(G) and Seed, and optionally an ID of the secondary device, referred to as ID(Secondary), are embedded in a quick response (QR) code by the client's secondary device 1006 and displayed on the screen of the secondary device 1006. The content of the QR code is read by the camera on the client's primary device 1004 by taking a photo of the QR cod displayed on the screen of the secondary device 1006. Seed is used by client's primary device 1004 as a seed in the same random number generator used by the master node 100 to generate Mₐ. Mₐ⊕Mₐ⊕G=G is computed by the client's primary device 1004. The client's primary device 1004 computes Sig(G) and compares with Sig(G) received from the client's secondary device 1006 to verify authenticity of G. Optionally, the client's primary device 1004 computes ID(Secondary) and compares with ID(Secondary) received from the client's secondary device 1006 to verify authenticity of the secondary device 1006 at the primary device 1004. Optionally, the client's primary device 1004 mixes ID(Secondary) with an ID of the primary device 1004 and sends the result, referred to as ID(Primary, Secondary) to the master node 1002. The master node 1002 regenerates ID(Primary, Secondary), compares the two copies, and verifies if both the primary device 1004 and the secondary device 1006 are authentic. Optionally, the master node 1002, upon identifying the client, adds the credentials of the primary device 1004 related to the particular client registered at the master node 1002 to its firewall setting to facilitate future access.

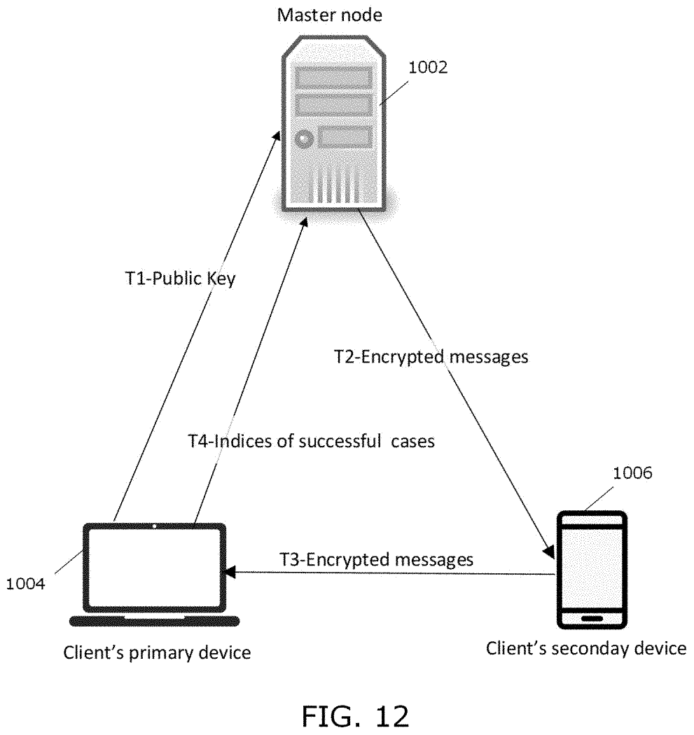

FIG. 12 depicts an embodiment for inclusion of a secondary device in using public key to establish an encryption key. At time T1, the client's primary device 1004 sends the public key to the master node 1002. At time T2, encrypted messages, encrypted utilizing the public key, are transmitted by the master node 1002 to the client's secondary device 1006. At time T3, the encrypted messages are transmitted to the client's primary device 1004 by the client's secondary device 1006, for example, via Bluetooth connection, Universal Serial Bus (USB) connection, or QR code. At time T4, Indices of successful decryption are transmitted. Optionally, the master node 1002, upon identifying the client, adds the credentials of the primary device 1004 related to the particular client registered at the master node 1002 to its firewall setting to facilitate future access.

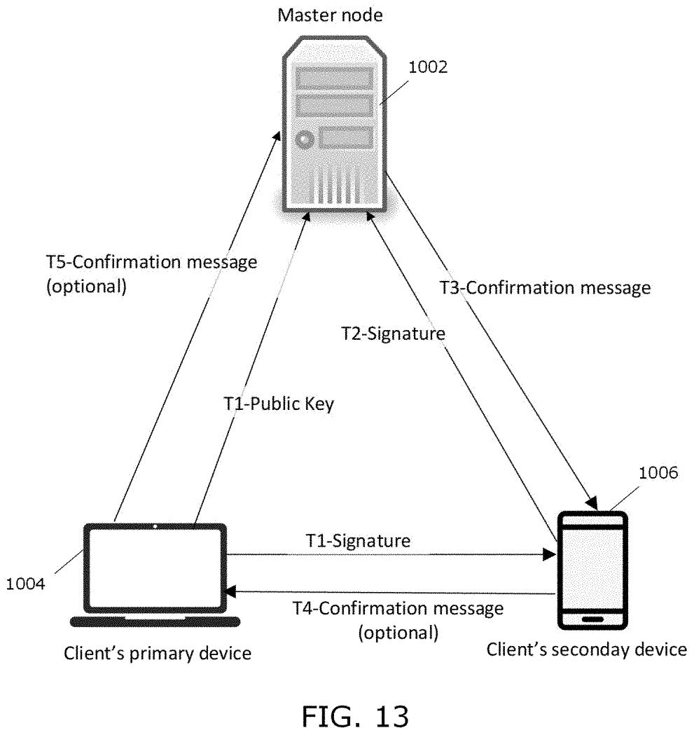

FIG. 13 through FIG. 26 depict various embodiments for integrating authentication with key generation, while: (1) improving immunity to man-in-the-middle-attack, (2) hiding or concealing public key, (3) verifying authenticity of public key, and (4) verifying authenticity of a client's primary device 1004 and secondary device 1006 in two-factor authentication. Notations such as T1, T2, T3, and so forth specify order of operation in time, for example, two operations notated by T1 are both executed before an operation notated by T2. The verification loop in FIG. 13 through FIG. 18, at T3, T4 and T5, is optional. The verification loop counters unauthorized access. When the link from the secondary device 1006 to the master node 1002 is compromised, the return path starting from the master node 1002 to the secondary device 1006 (T3), from the secondary device 1006 continuing to the primary device 1004 (T4) and from the primary 1004 continuing to the master node 1005 (T5) relies on the connection from the master node 1002 to the secondary device 1006 to inform the secondary device 1006 and the primary device 1004 that an attempt for access has been pursued, and, if the access request is legitimate, the primary device 1004 informs the master node 1002, and subsequently access is granted. In other embodiments, a similar purpose is realized by the master node 1002 sending a confirmation request to the secondary device 1006 and receiving the response directly from the secondary device 1006. When illegitimate access is in progress, the secondary device 1006 receives a request without prior context. When an access request is illegitimate, the communication from the secondary device 1006 to the master node 1002 at time T2 has been falsified, for example, when an illegitimate node has impersonated the legitimate secondary node 1006. The legitimate secondary node 1006 may detect such a fraudulent case by simply keeping a record of its transmissions to the master node 1002.

FIG. 13 depicts an embodiment for inclusion of a secondary device in using public key to establish an encryption key. At time T1, the client's primary device 1004 sends the public key to the master node 1002. Also at T1, a signature associated with the public key is sent from the client's primary device 1004 to the client's secondary device 1006, for example, via Bluetooth connection, USB connection, or QR code. At time T2, a signature associated with the public key, advantageously mixed with an ID of the secondary device 1006 that is registered at the master node 1002 and the mixture of the two permits verifying authenticity of public key as well as authenticity of the secondary device 1006, is sent from the secondary device 1006 to the master node 1002. At time T3, a confirmation message is sent from the master node 1002 to the client's secondary device 1006 upon receiving data from the secondary device 1006 to check the link from the master node 1002 to the secondary device 1006. At time T4, an optional enhancement includes the client's secondary device 1006 sending a confirmation message to the client's primary device 1004. At time T5, an optional enhancement includes the client's primary device 1004 sending a confirmation message to the master node 1002. The master node 1002 sends an alarm message to the client, for example by sending an email or SMS, when the expected data from the client's secondary device 1006 does not arrive within a predetermined time limit. This delay is an indication of an attempt for illegitimate access. Optionally, the master node 1002, upon identifying the client, adds the credentials of the primary device 1004 and/or the second device 1006 related to the particular client registered at the master node 1002 to its firewall setting to facilitate future access by these devices 1004, 1006.

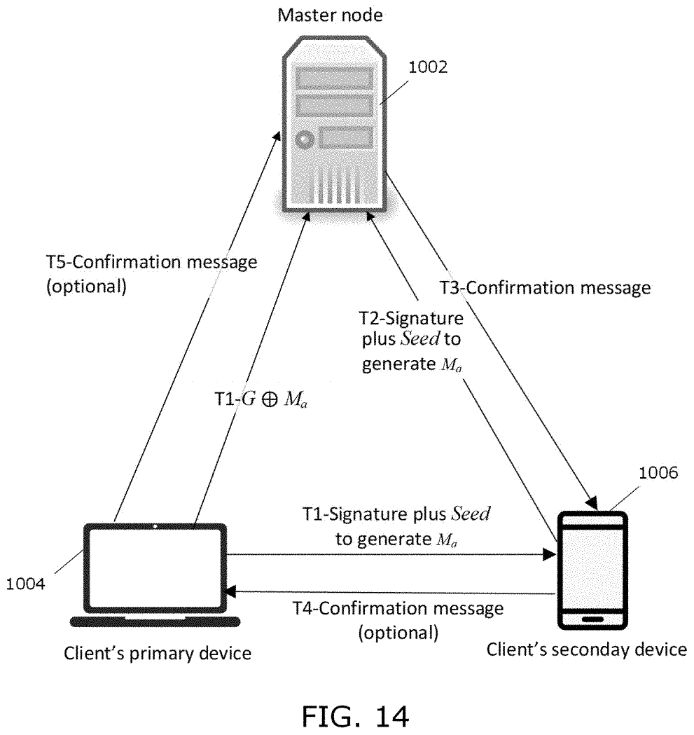

FIG. 14 depicts an embodiment for inclusion of a secondary device in using public key to establish an encryption key. A random number Seed is generated by the client's primary device 1004. Seed is used as a seed in a random number generator, generating Mₐ. G⊕Mₐ is computed by the client's primary device 1004. At time T1, G⊕Mₐ is sent by the client's primary device 1004 to the master node 1002. Also at T1, a signature associated with the public key plus the Seed used to generate Mₐ is sent from the client's primary device 1004 to the client's secondary device 1006, for example, via Bluetooth connection, USB connection, or QR code. At time T2, a signature associated with the public key plus the Seed used to generate Mₐ is sent from the secondary device 1006 to the master node 1002. At time T3, a confirmation message is sent from the master node 1002 to the client's secondary device 1006 upon receiving data from secondary device 1006 to check the link from the master node 1002 to the secondary device 1006. At time T4, an optional enhancement includes the client's secondary device 1006 sending a confirmation message to the client's primary device 1004. At time T5, an optional enhancement includes the client's primary device 1004 sending a confirmation message to the master node 1002. The master node 1002 sends an alarm message to the client, for example by sending an email or SMS, when the expected data from the client's secondary device 1006 does not arrive within a predetermined time limit. This delay is an indication of an attempt for illegitimate access. Optionally, the master node 1002, upon identifying the client, adds the credentials of the primary device 1004 and/or the second device 1006 related to the particular client registered at the master node 1002 to its firewall setting to facilitate future access by these devices 1004, 1006.

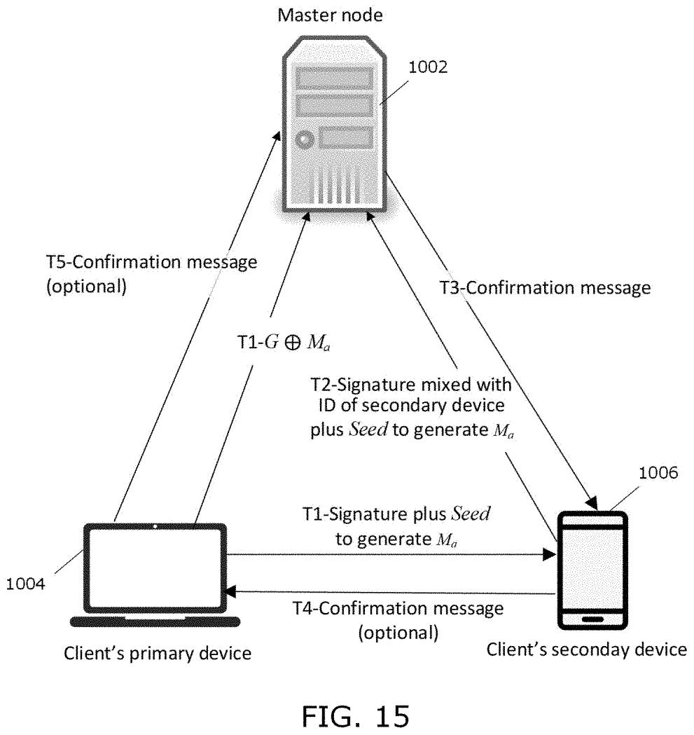

FIG. 15 depicts an embodiment for inclusion of a secondary device in using public key to establish an encryption key. The method may be applied, for example, to an asymmetric key, such as an asymmetric part of a public/private key pair, such as the public key. A random number Seed is generated by the client's primary device 1004. Seed is used as a seed, also referred to as authentication key data, in a random number generator, generating Mₐ. Mₐ is also referred to as an authentication key. G⊕Mₐ is computed by the client's primary device 1004. At time T1, G⊕Mₐ is sent by the client's primary device 1004 to the master node 1002, also referred to as a server, over a first communication link. Also at T1, a signature associated with the public key plus the Seed used to generate Mₐ is sent from the client's primary device 1004 to the client's secondary device 1006, for example, via Bluetooth connection, USB connection, or QR code. The client's secondary device 1006, also referred to as an auxiliary device, is advantageously previously registered at the master node and has a device identification (ID) that is advantageously stored at the master node 1002. At time T2, a signature associated with the public key, mixed with an ID of the secondary device 1006 that is registered at the master node 1002 and the mixture of the two permits verifying authenticity of the public key as well as authenticity of the secondary device 1006, plus Seed used to generate Mₐ is sent from the secondary device 1006 to the master node 1002 over a second communication link. The asymmetric key is verified by decrypting the encrypted asymmetric key using the seed, i.e., the authentication key data. A local signature of the public key is generated at the master node 1002. The master node 1002 mixes the local signature of the public key with the previously stored device ID (stored at the master node 1002) of the previously registered secondary device 1006 to obtain a local mixture. The local mixture with the mixture received from the secondary device 1006 are compared. When the local mixture and the received mixture match, the primary device 1004 and/or the secondary device 1006 are authenticated, and the decrypted public key is used to exchange further encrypted messages with the primary device 1004. The further encrypted messages may include another key, such as an AES 256 key or other encryption key. At time T3, a confirmation message is sent from the master node 1002 to the client's secondary device 1006 upon receiving data from secondary device 1006 to check the link from the master node 1002 to the secondary device 1006. At time T4, an optional enhancement includes the client's secondary device 1006 sending a confirmation message to the client's primary device 1004. At time T5, an optional enhancement includes the client's primary device 1004 sending a confirmation message to the master node 1002. The master node 1002 sends an alarm message to the client, for example by sending an email or SMS, when the expected data from the client's secondary device 1006 does not arrive within a predetermined time limit. This delay is an indication of an attempt for illegitimate access. Optionally, the master node 1002, upon identifying the client, adds the credentials of the primary device 1004 and/or the second device 1006 related to the particular client registered at the master node 1002 to its firewall setting to facilitate future access by these devices 1004, 1006.

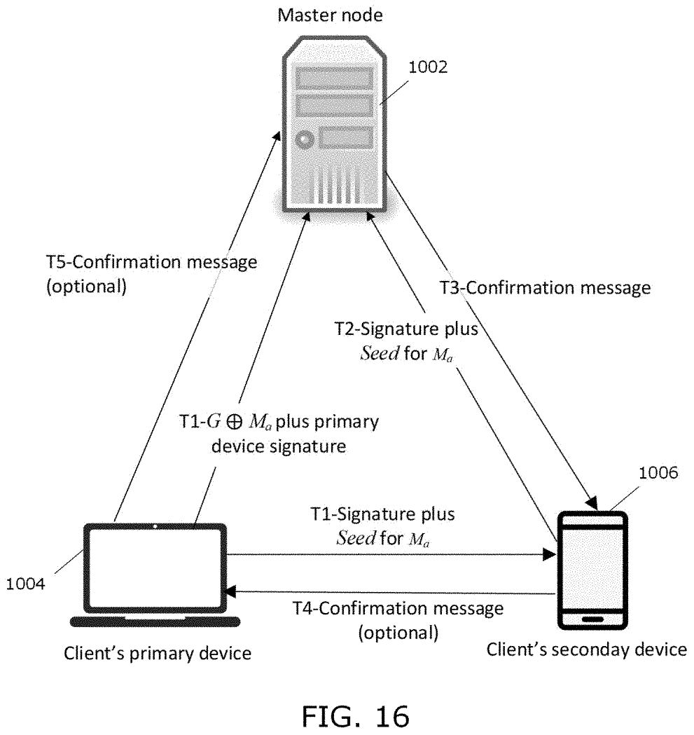

FIG. 16 depicts an embodiment for inclusion of a secondary device in using public key to establish an encryption key. A random number Seed is generated by the client's primary device 1004. Seed is used as a seed in a random number generator, generating Mₐ. G⊕Mₐ is computed by the client's primary device 1004. At time T1, G⊕Mₐ plus a signature identifying the primary device 1004 as registered at the master node 1002 are sent by the client's primary device 1004 to the master node 1002. Also at T1, a signature associated with the public key plus the Seed used to generate Mₐ is sent from the client's primary device 1004 to the client's secondary device 1006, for example, via Bluetooth connection, USB connection, or QR code. At time T2, a signature associated with the public key plus the Seed used to generate Mₐ is sent from the the secondary device 1006 to the master node 1002. At time T3, a confirmation message is sent from the master node 1002 to the client's secondary device 1006 upon receiving data from secondary device 1006 to check the link from the master node 1002 to the secondary device 1006. At time T4, an optional enhancement includes the client's secondary device 1006 sending a confirmation message to the client's primary device 1004. At time T5, an optional enhancement includes the client's primary device 1004 sending a confirmation message to the master node 1002. The master node 1002 sends an alarm message to the client, for example by sending an email or SMS, when the expected data from the client's secondary device 1006 does not arrive within a predetermined time limit. This delay is an indication of an attempt for illegitimate access. Optionally, the master node 1002, upon identifying the client, adds the credentials of the primary device 1004 and/or the second device 1006 related to the particular client registered at the master node 1002 to its firewall setting to facilitate future access by these devices 1004, 1006.

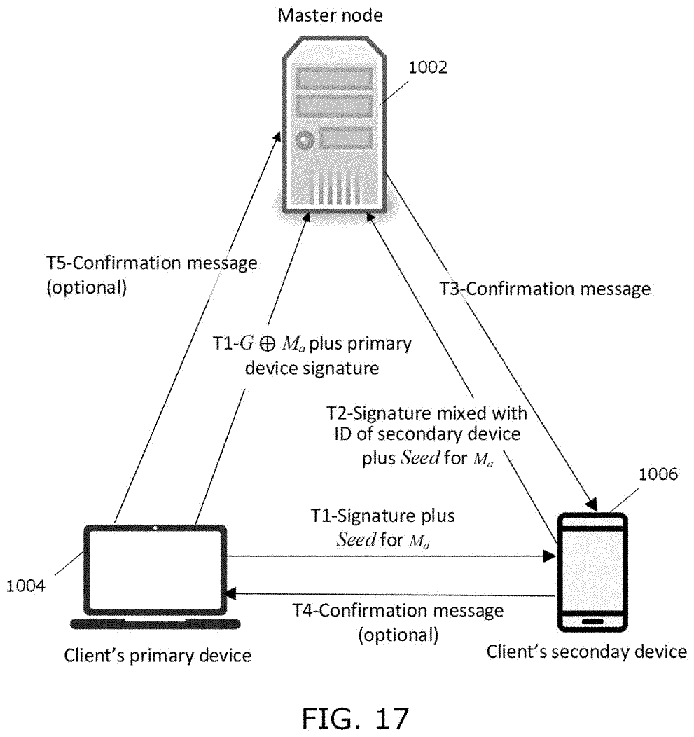

FIG. 17 depicts an embodiment for inclusion of a secondary device in using public key to establish an encryption key. A random number Seed is generated by the client's primary device 1004. Seed is used as a seed in a random number generator, generating Mₐ. G⊕Mₐ is computed by the client's primary device 1004. At time T1, G⊕Mₐ plus a signature identifying the primary device 1004 as registered at the master node 1002 are sent by the client's primary device 1004 to the master node 1002. Also at T1, a signature associated with the public key plus Seed used to generate Mₐ are sent from the client's primary device 1004 to the client's secondary device 1006, for example, via Bluetooth connection, USB connection, or QR code. At time T2, a signature associated with the public key, mixed with an ID of the secondary device 1006 that is registered at the master node 1002 and the mixture of the two permits verifying authenticity of the public key as well as authenticity of the secondary device 1006, plus Seed used to generate Mₐ is sent from the secondary device 1006 to the master node 1002. At time T3, a confirmation message is sent from the master node 1002 to the client's secondary device 1006 upon receiving data from secondary device 1006 to check the link from the master node 1002 to the secondary device 1006. At time T4, an optional enhancement includes the client's secondary device 1006 sending a confirmation message to the client's primary device 1004. At time T5, an optional enhancement includes the client's primary device 1004 sending a confirmation message to the master node 1002. The master node 1002 sends an alarm message to the client, for example by sending an email or SMS, when the expected data from the client's secondary device 1006 does not arrive within a predetermined time limit. This delay is an indication of an attempt for illegitimate access. Optionally, the master node 1002, upon identifying the client, adds the credentials of the primary device 1004 and/or the second device 1006 related to the particular client registered at the master node 1002 to its firewall setting to facilitate future access by these devices 1004, 1006.

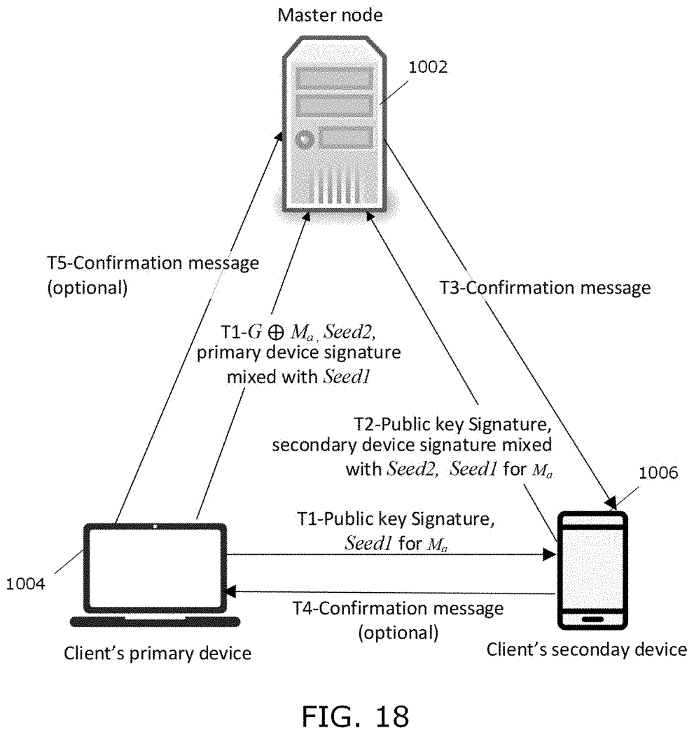

FIG. 18 depicts an embodiment for inclusion of a secondary device in using public key to establish an encryption key. A random number Seed1 is generated by the client's primary device 1004. Seed1 is used as a seed in a random number generator, generating Mₐ. G⊕Mₐ is computed by the client's primary device 1004. At time T1, G⊕Mₐ, Seed2, and a signature identifying the primary device 1004 as registered at the master node 1002 and mixed with Seed1 are sent by the client's primary device 1004 to the master node 1002. Also at T1, a signature associated with the public key plus Seed1 used to generate Mₐ are sent from the client's primary device 1004 to the client's secondary device 1006, for example, via Bluetooth connection, USB connection, or QR code. At time T2, a signature associated with the public key, a signature identifying the secondary device 1006 as registered at the master node and mixed with Seed2, plus Seed1 used to generate Mₐ are sent from the secondary device 1006 to the master node 1002. At time T3, a confirmation message is sent from the master node 1002 to the client's secondary device 1006 upon receiving data from secondary device 1006 to check the link from the master node 1002 to the secondary device 1006. At time T4, an optional enhancement includes the client's secondary device 1006 sending a confirmation message to the client's primary device 1004. At time T5, an optional enhancement includes the client's primary device 1004 sending a confirmation message to the master node 1002. The master node 1002 verifies the signature of the primary device 1004 and the signature of the secondary device 1006. If either signature has a conflict, the master node 1002 sends a message to the primary device 1004 requesting that the client enters his/her password. The master node 1002 sends an alarm message to the client, for example by sending an email or SMS, when the expected data from the client's secondary device 1006 does not arrive within a predetermined time limit. This delay is an indication of an attempt for illegitimate access. Optionally, the master node 1002, upon identifying the client, adds the credentials of the primary device 1004 and/or the second device 1006 related to the particular client registered at the master node 1002 to its firewall setting to facilitate future access by these devices 1004, 1006.

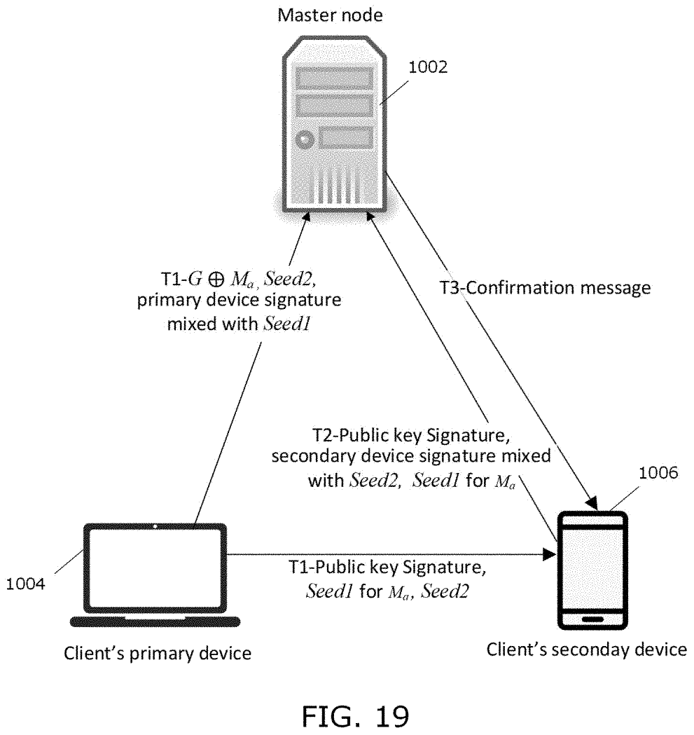

FIG. 19 depicts an embodiment where confirmation by the master node does not propagate beyond the secondary device 1006. A similar technique may be used in conjunction with embodiments depicted in FIG. 13 through FIG. 26. A random number Seed1 is generated by the client's primary device 1004. Seed1 is used as a seed in a random number generator, generating Mₐ. G⊕Mₐ is computed by the client's primary device 1004. At time T1, G⊕Mₐ, Seed2, and a signature identifying the primary device 1004 as registered at the master node 1002 and mixed with Seed1 are sent by the client's primary device 1004 to the master node 1002. Also at T1, a signature associated with the public key plus Seed1 used to generate Mₐ and Seed2 are sent from the client's primary device 1004 to the client's secondary device 1006, for example, via Bluetooth connection, USB connection, or QR code. At time T2, a signature associated with the public key, a signature identifying the secondary device 1006 as registered at the master node and mixed with Seed2, plus Seed1 used to generate Mₐ are sent from the secondary device 1006 to the master node 1002. At time T3, a confirmation message is sent from the master node 1002 to the client's secondary device 1006 upon receiving data from secondary device 1006 to check the link from the master node 1002 to the secondary device 1006. The master node 1002 verifies the signature of the primary device 1004 and the signature of the secondary device 1006. If either signature has a conflict, the master node 1002 sends a message to the primary device 1004 requesting that the client enters his/her password. The master node 1002 sends an alarm message to the client, for example by sending an email or SMS, when the expected data from the client's secondary device 1006 does not arrive within a predetermined time limit. This delay is an indication of an attempt for illegitimate access. Optionally, the master node 1002, upon identifying the client, adds the credentials of the primary device 1004 and/or the second device 1006 related to the particular client registered at the master node 1002 to its firewall setting to facilitate future access by these devices 1004, 1006.

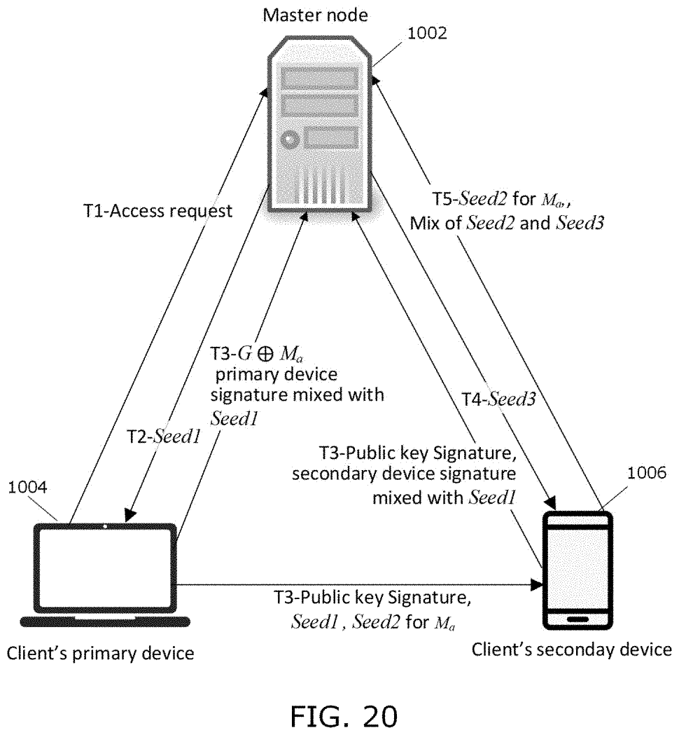

FIG. 20 depicts an embodiment where confirmation by the master node does not propagate beyond the secondary device 1006, and the information to be sent from the secondary device 1006 to the master node 1002 is sent in two separate time slots. A similar technique may be used in conjunction with embodiments depicted in FIG. 13 through FIG. 18. At time T1, the client's primary device 1004 sends an access request to the master node 1002. Random number Seed1 is generated by the master node 1002. At time T2, Seed1 is sent from the master node 1002 to the client's primary device 1004. Random number Seed2 is generated by the client's primary device 1004. Seed2 is used as a seed in a random number generator, generating Mₐ. G⊕Mₐ is computed by the client's primary device 1004. At time T3, G⊕Mₐ and a signature identifying the primary device 1004 as registered at the master node 1002 and mixed with Seed1 are sent by the client's primary device 1004 to the master node 1002. Also at T3, a signature associated with the public key plus Seed1 and Seed2 used to generate Mₐ are sent from the client's primary device 1004 to the client's secondary device 1006, for example, via Bluetooth connection, USB connection, or QR code. Also at time T3, a signature associated with the public key and a signature identifying the secondary device 1006 as registered at the master node and mixed with Seed1, are sent from the secondary device 1006 to the master node 1002. Random number Seed3 is generated by the master node 1002. At time T4, Seed3 is sent from the master node 1002 to the client's secondary device 1006. At time T5, Seed2 used to generate Mₐ and a mix of Seed2 and Seed3 are sent from the client's secondary device 1006 to the master node 1002. The master node 1002 verifies the signature of the primary device 1004 and the signature of the secondary device 1006. If either signature has a conflict, the master node 1002 sends a message to the primary device 1004 requesting that the client enters his/her password. The master node 1002 sends an alarm message to the client, for example by sending an email or SMS, when the expected data from the client's secondary device 1006 does not arrive within a predetermined time limit. This delay is an indication of an attempt for illegitimate access. Optionally, the master node 1002, upon identifying the client, adds the credentials of the primary device 1004 and/or the second device 1006 related to the particular client registered at the master node 1002 to its firewall setting to facilitate future access by these devices 1004, 1006.

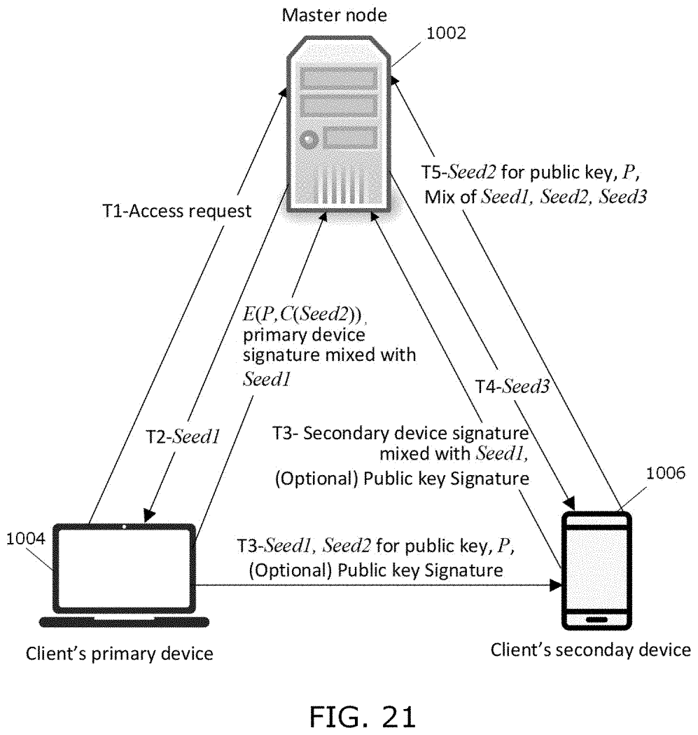

FIG. 21 depicts an embodiment where the public key is encrypted, and the encryption key is sent through the secondary device to the master node. At time T1, the client's primary device 1004 sends an access request to the master node 1002. Random number Seed1 is generated by the master node 1002. At time T2, Seed1 is sent from the master node 1002 to the client's primary device 1004. Random number Seed2 is generated by the client's primary device 1004. Seed2 generates the encryption key for encrypting public key, P. At time T3, E(P,C(Seed2)) and a signature identifying the primary device 1004 as registered at the master node 1002 and mixed with Seed1 are sent by the client's primary device 1004 to the master node 1002. E(P,C(Seed2)) is an encryption function, for example, AES256, encrypting public key, P, using the encryption key C(Seed2). C(Seed2) may advantageously be a one-way function generating encryption key for P using Seed2, for example, Seed2 may be 64 random bits hashed 4000 times to generate a 256bits key for AES256. Also at T3, Seed1 and Seed2 and optionally a signature associated with the public key are sent from the client's primary device 1004 to the client's secondary device 1006, for example, via Bluetooth connection, USB connection, or QR code. Also at time T3, a signature identifying the secondary device 1006 as registered at the master node and mixed with Seed1 and optionally a signature associated with the public key are sent from the secondary device 1006 to the master node 1002. Random number Seed3 is generated by the master node 1002. At time T4, Seed3 is sent from the master node 1002 to the client's secondary device 1006. At time T5, Seed2 used to generate the encryption key for encrypting public key, P, and a mix of Seed1, Seed2, and Seed3 are sent from the client's secondary device 1006 to the master node 1002. The master node 1002 verifies the signature of the primary device 1004 and the signature of the secondary device 1006. If either signature has a conflict, the master node 1002 sends a message to the primary device 1004 requesting that the client enters his/her password. The master node 1002 sends an alarm message to the client, for example by sending an email or SMS, when the expected data from the client's secondary device 1006 does not arrive within a predetermined time limit. This delay is an indication of an attempt for illegitimate access. Optionally, the master node 1002, upon identifying the client, adds the credentials of the primary device 1004 and/or the second device 1006 related to the particular client registered at the master node 1002 to its firewall setting to facilitate future access by these devices 1004, 1006.

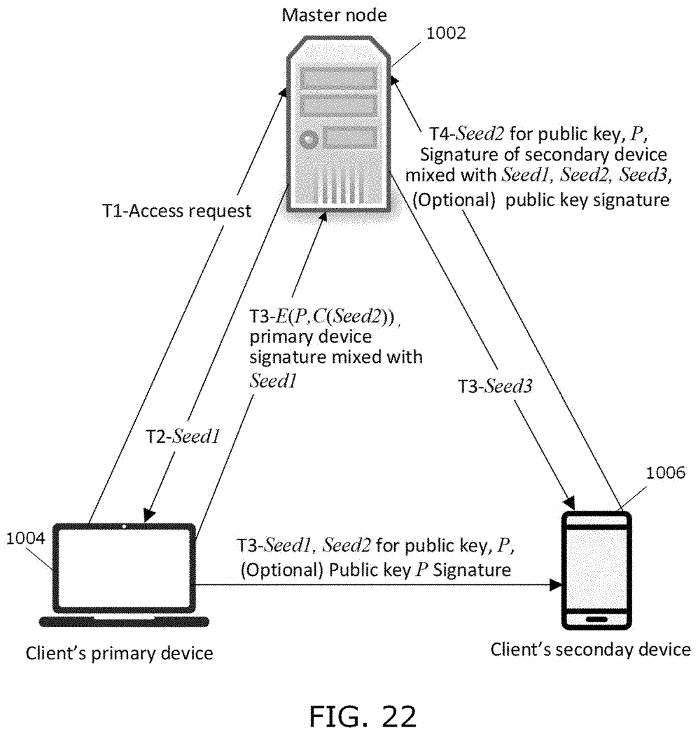

FIG. 22 depicts an embodiment where the public key is encrypted, and the encryption key is sent through the secondary device to the master node. At time T1, the client's primary device 1004 sends an access request to the master node 1002. Random number Seed1 is generated by the master node 1002. At time T2, Seed1 is sent from the master node 1002 to the client's primary device 1004. Random number Seed2 is generated by the client's primary device 1004. Seed2 generates the encryption key for encrypting public key, P. At time T3, E(P,C(Seed2)) and a signature identifying the primary device 1004 as registered at the master node 1002 and mixed with Seed1 are sent by the client's primary device 1004 to the master node 1002. E(P,C(Seed2)) is an encryption function, for example, AES256, encrypting public key, P, using the encryption key C(Seed2). C(Seed2) may advantageously be a one-way function generating encryption key for P using Seed2, for example, Seed2 may be 64 random bits hashed 4000 times to generate a 256bits key for AES256. Also at T3, Seed1 and Seed2 and optionally a signature associated with the public key, P, are sent from the client's primary device 1004 to the client's secondary device 1006, for example, via Bluetooth connection, USB connection, or QR code. Random number Seed3 is generated by the master node 1002. At time T3, Seed3 is sent from the master node 1002 to the client's secondary device 1006. At time T4, Seed2 used to generate the encryption key for encrypting public key, P, and a signature of the secondary device 1006 mixed with Seed1, Seed2, and Seed3 and optionally a signature associated with public key are sent from the client's secondary device 1006 to the master node 1002. The master node 1002 verifies the signature of the primary device 1004 and the signature of the secondary device 1006. If either signature has a conflict, the master node 1002 sends a message to the primary device 1004 requesting that the client enters his/her password. The master node 1002 sends an alarm message to the client, for example by sending an email or SMS, when the expected data from the client's secondary device 1006 does not arrive within a predetermined time limit. This delay is an indication of an attempt for illegitimate access. Optionally, the master node 1002, upon identifying the client, adds the credentials of the primary device 1004 and/or the second device 1006 related to the particular client registered at the master node 1002 to its firewall setting to facilitate future access by these devices 1004, 1006.

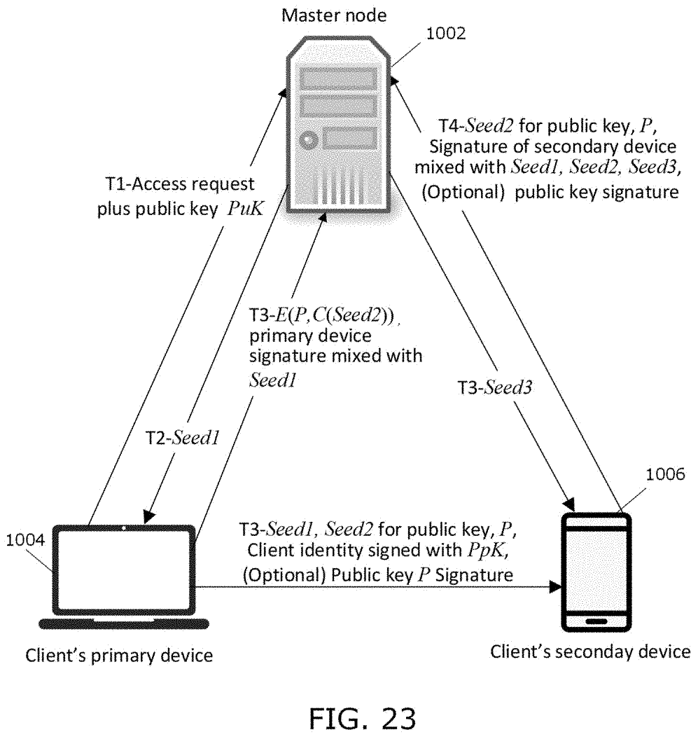

FIG. 23 depicts an embodiment where the public key is encrypted, and the encryption key is sent through the secondary device 1006 to the master node 1002. In addition, the identity of the client is verified by relying on a conventional public/private key for generating signatures with an identifying signature sent through the secondary device 1006 to the master node 1002. At time T1, the client's primary device 1004 sends an access request plus a public key PuK for authentication to the master node 1002. Random number Seed1 is generated by the master node 1002. At time T2, Seed1 is sent from the master node 1002 to the client's primary device 1004. Random number Seed2 is generated by the client's primary device 1004. Seed2 generates the encryption key for encrypting public key, P. At time T3, E(P,C(Seed2)) and a signature identifying the primary device 1004 as registered at the master node 1002 and mixed with Seed1 are sent by the client's primary device 1004 to the master node 1002. E(P,C(Seed2)) is an encryption function, for example, AES256, encrypting public key, P, using the encryption key C(Seed2). C(Seed2) may advantageously be a one-way function generating encryption key for P using Seed2, for example, Seed2 may be 64 random bits hashed 4000 times to generate a 256bits key for AES256. Also at T3, Seed1, Seed2, a client identity signed with PpK, and optionally a signature associated with the public key, P, are sent from the client's primary device 1004 to the client's secondary device 1006, for example, via Bluetooth connection, USB connection, or QR code. PuK and PpK are, for example, a conventional public/private key pair used for signing/confirming identities. Random number Seed3 is generated by the master node 1002. At time T3, Seed3 is sent from the master node 1002 to the client's secondary device 1006. At time T4, Seed2 used to generate the encryption key for encrypting public key, P, a signature of the secondary device 1006 mixed with Seed1, Seed2, and Seed3, and optionally a signature associated with public key are sent from the client's secondary device 1006 to the master node 1002. The master node 1002 verifies the signature of the primary device 1004 and the signature of the secondary device 1006. If either signature has a conflict, the master node 1002 sends a message to the primary device 1004 requesting that the client enters his/her password. The master node 1002 sends an alarm message to the client, for example by sending an email or SMS, when the expected data from the client's secondary device 1006 does not arrive within a predetermined time limit. This delay is an indication of an attempt for illegitimate access. Optionally, the master node 1002, upon identifying the client, adds the credentials of the primary device 1004 and/or the second device 1006 related to the particular client registered at the master node 1002 to its firewall setting to facilitate future access by these devices 1004, 1006.

FIG. 24 depicts an embodiment where a primary (trusted) device 1004 vouches for a secondary device 1006. At time T1, the client's primary device 1004 sends an access request plus a public key PuK for authentication to the master node 1002. Random number Seed1 is generated by the master node 1002. At time T2, Seed1 is sent from the master node 1002 to the client's primary device 1004. Random number Seed2 is generated by the client's primary device 1004. Seed2 generates the encryption key for encrypting public key, P. At time T3, E(P,C(Seed2)) and a signature identifying the primary device 1004 as registered at the master node 1002 and mixed with Seed1 are sent by the client's primary device 1004 to the master node 1002. E(P,C(Seed2)) is an encryption function, for example, AES256, encrypting public key, P, using the encryption key C(Seed2). C(Seed2) may advantageously be a one-way function generating encryption key for P using Seed2, for example, Seed2 may be 64 random bits hashed 4000 times to generate a 256bits key for AES256. Also at T3, Seed1, Seed2, PpK, and optionally a signature associated with the public key, P, are sent from the client's primary device 1004 to the client's secondary device 1006, for example, via Bluetooth connection, USB connection, or QR code. PuK and PpK are, for example, a conventional public/private key pair used for signing/confirming identities. Random number Seed3 is generated by the master node 1002. At time T3, Seed3 is sent from the master node 1002 to the client's secondary device 1006. At time T4, Seed2 used to generate the encryption key for encrypting public key, P, a signature of the secondary device 1006 mixed with Seed1, Seed2, and Seed3, a device identity signed with PpK, and optionally a signature associated with public key are sent from the client's secondary device 1006 to the master node 1002. The master node 1002 verifies the signature of the primary device 1004 and the signature of the secondary device 1006. If either signature has a conflict, the master node 1002 sends a message to the primary device 1004 requesting that the client enters his/her password. The master node 1002 sends an alarm message to the client, for example by sending an email or SMS, when the expected data from the client's secondary device 1006 does not arrive within a predetermined time limit. This delay is an indication of an attempt for illegitimate access. Optionally, the master node 1002, upon identifying the client, adds the credentials of the primary device 1004 and/or the second device 1006 related to the particular client registered at the master node 1002 to its firewall setting to facilitate future access by these devices 1004, 1006.

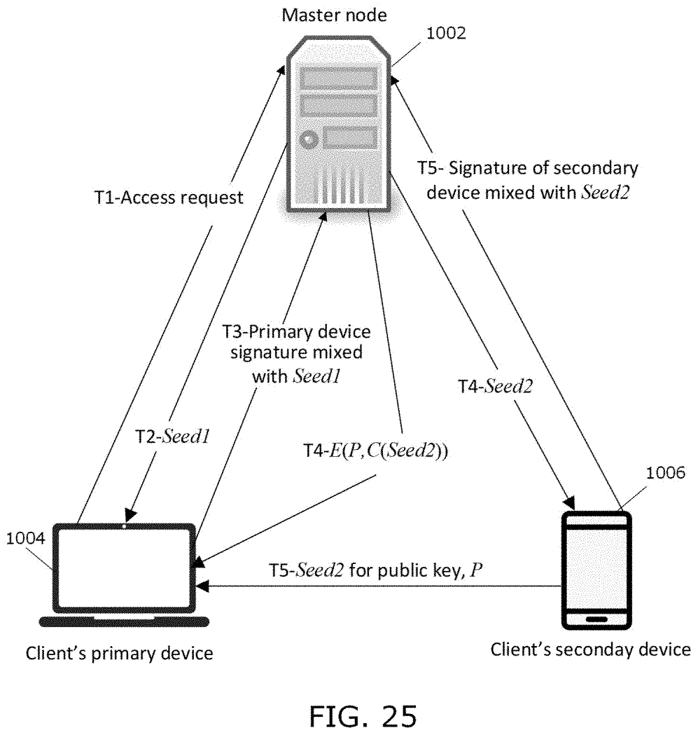

FIG. 25 depicts an embodiment where the public key is encrypted and sent to a primary device 1004 while the seed generating the key for encrypting public key is sent to the secondary device 1006, and then from secondary device 1006 to the primary device 1004 where the key is used to decrypt the public key. At time T1, the client's primary device 1004 sends an access request to the master node 1002. Random number Seed1 is generated by the master node 1002. At time T2, Seed1 is sent from the master node 1002 to the client's primary device 1004. Random number Seed2 is generated by the master node 1002. Seed2 generates the encryption key for encrypting public key, P. At time T3, a signature identifying the primary device 1004 as registered at the master node 1002 and mixed with Seed1 is sent by the client's primary device 1004 to the master node 1002. At time T4, E(P,C(Seed2)) is sent from the master node 1002 to the client's primary device 1004. E(P,C(Seed2)) is an encryption function, for example, AES256, encrypting public key, P, using the encryption key C(Seed2). C(Seed2) may advantageously be a one-way function generating encryption key for P using Seed2, for example, Seed2 may be 64 random bits hashed 4000 times to generate a 256bits key for AES256. At time T4, Seed2 is sent from the master node 1002 to the client's secondary device 1006. At time T5, a signature of the secondary device 1006 mixed with Seed2 is sent from the client's secondary device 1006 to the master node 1002. Also at time T5, Seed2 is sent from the client's secondary device 1006 to the client's primary device 1004, for example, via Bluetooth connection, USB connection, or QR code. Optionally, the master node 1002, upon identifying the client, adds the credentials of the primary device 1004 and/or the second device 1006 related to the particular client registered at the master node 1002 to its firewall setting to facilitate future access by these devices 1004, 1006.

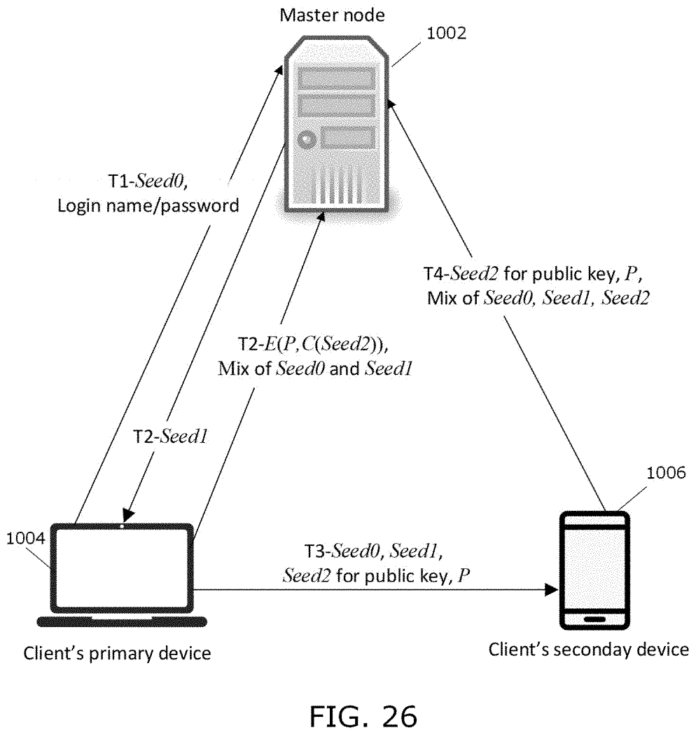

FIG. 26 depicts a simplified embodiment utilizing a primary device 1004 and a secondary device 1006 to avert man-in-the-middle attacks. At time T1, the client's primary device 1004 sends a login name and password with Seed0 to the master node 1002. Random number Seed0 is generated by the client's primary device 1004. Random number Seed1 is generated by the master node 1002. At time T2, Seed1 is sent from the master node 1002 to the client's primary device 1004. Random number Seed2 is generated by the client's primary device 1004. Seed2 generates the encryption key for encrypting public key, P. At time T2, E(P,C(Seed2)) and a mix of Seed0 and Seed1 are sent from the client's primary device 1004 to the master node 1002. E(P,C(Seed2)) is an encryption function, for example, AES256, encrypting public key, P, using the encryption key C(Seed2). C(Seed2) may advantageously be a one-way function generating encryption key for P using Seed2, for example, Seed2 may be 64 random bits hashed 4000 times to generate a 256bits key for AES256. At time T3, Seed0 and Seed1 as well as Seed2 used to generate the encryption key for encrypting public key, P, are sent from the client's primary device 1004 to the client's secondary device 1006, for example, via Bluetooth connection, USB connection, or QR code. At time T4, Seed2 used to generate the encryption key for encrypting public key, P, and a mix of Seed1, Seed2, and Seed3 are sent from the client's secondary device 1006 to the master node 1002. Optionally, the master node 1002, upon identifying the client, adds the credentials of the primary device 1004 and/or the second device 1006 related to the particular client registered at the master node 1002 to its firewall setting to facilitate future access by these devices 1004, 1006.

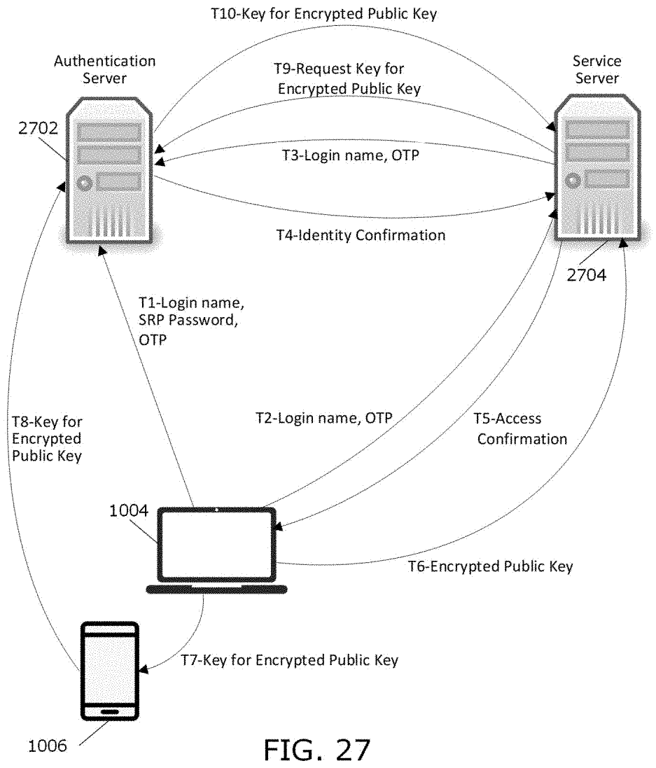

FIG. 27 depicts an embodiment utilizing a primary device 1004 and a secondary device 1006 as well as an authentication server and service server to avert man-in-the-middle attacks. At time T1, the client's primary device 1004 sends a login name, a password using Secure Remote Password (SRP) protocol, and a One-Time Password (OTP) to an authentication server 2702. At time T2, the client's primary device 1004 sends the login name and the OTP to a service server 2704, such as a Virtual Private Network (VPN) server. At time T3, service server 2704 sends the login name and the OTP to the authentication server 2702. At time T4, confirmation of identity is provided from the authentication server 2702 to the service server 2704. At time T5, confirmation of access is provided from the service server 2704 to the client's primary device 1004. At time T6, the client's primary device 1004 sends the encrypted public key to the service server 2704. At time T7, the client's primary device 1004 sends the key for the encrypted public key to the client's secondary device 1006. At time T8, the client's secondary device 1006 sends the key for the encrypted public key to the authentication server 2702. At time T9, the service server 2704 requests the key for the encrypted public key from the authentication server 2702. At time T10, the authentication server 2702 sends the key for the encrypted public key to the service server 2704.

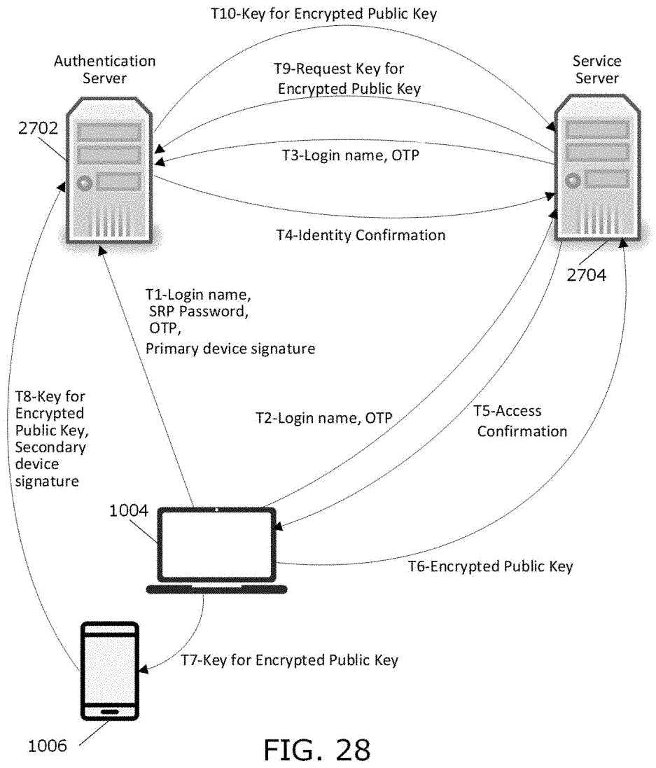

FIG. 28 depicts an embodiment utilizing a primary device 1004 and a secondary device 1006 to avert man-in-the-middle attacks, where a signature from each device, advantageously registered at an authentication server in a registration phase, enables multi-factor authentication. At time T1, the client's primary device 1004 sends a login name, a password using Secure Remote Password (SRP) protocol, a One-Time Password (OTP), and a primary device 1004 signature to an authentication server 2702. At time T2, the client's primary device 1004 sends the login name and the OTP to a service server 2704, such as a Virtual Private Network (VPN) server. At time T3, service server 2704 sends the login name and the OTP to the authentication server 2702. At time T4, confirmation of identity is provided from the authentication server 2702 to the service server 2704. At time T5, confirmation of access is provided from the service server 2704 to the client's primary device 1004. At time T6, the client's primary device 1004 sends the encrypted public key to the service server 2704. At time T7, the client's primary device 1004 sends the key for the encrypted public key to the client's secondary device 1006. At time T8, the client's secondary device 1006 sends the key for the encrypted public key and a secondary device 1006 signature to the authentication server 2702. At time T9, the service server 2704 requests the key for the encrypted public key from the authentication server 2702. At time T10, the authentication server 2702 sends the key for the encrypted public key to the service server 2704.

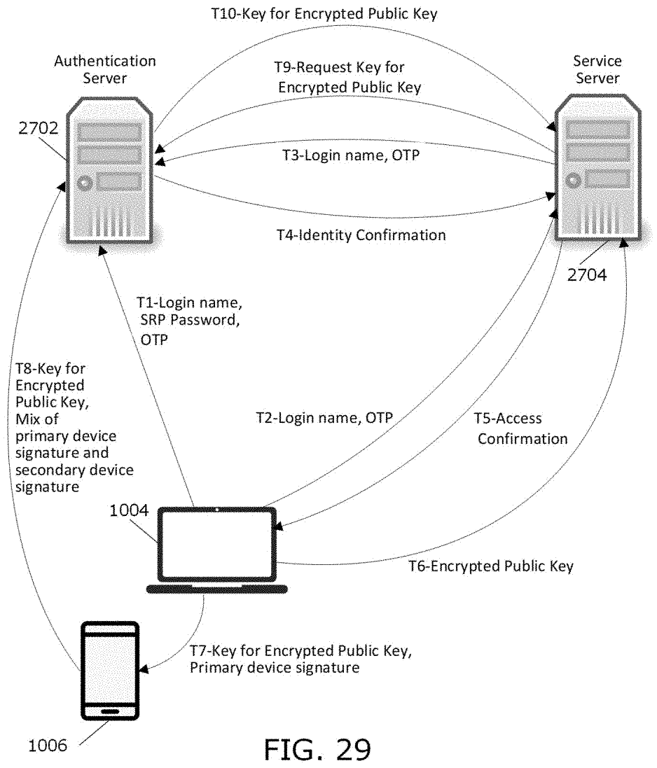

FIG. 29 depicts another embodiment utilizing a primary device 1004 and a secondary device 1006 to avert man-in-the-middle attacks, wherein a signature from each device, advantageously registered at an authentication server in a registration phase, enables multi-factor authentication. At time T1, the client's primary device 1004 sends a login name, a password using Secure Remote Password (SRP) protocol, and a One-Time Password (OTP) to an authentication server 2702. At time T2, the client's primary device 1004 sends the login name and the OTP to a service server 2704, such as a Virtual Private Network (VPN) server. At time T3, service server 2704 sends the login name and the OTP to the authentication server 2702. At time T4, confirmation of identity is provided from the authentication server 2702 to the service server 2704. At time T5, confirmation of access is provided from the service server 2704 to the client's primary device 1004. At time T6, the client's primary device 1004 sends the encrypted public key to the service server 2704. At time T7, the client's primary device 1004 sends the key for the encrypted public key and a primary device 1004 signature to the client's secondary device 1006. At time T8, the client's secondary device 1006 sends the key for the encrypted public key and a mix of the primary device 1004 signature and the secondary device 1006 signature to the authentication server 2702. At time T9, the service server 2704 requests the key for the encrypted public key from the authentication server 2702. At time T10, the authentication server 2702 sends the key for the encrypted public key to the service server 2704.

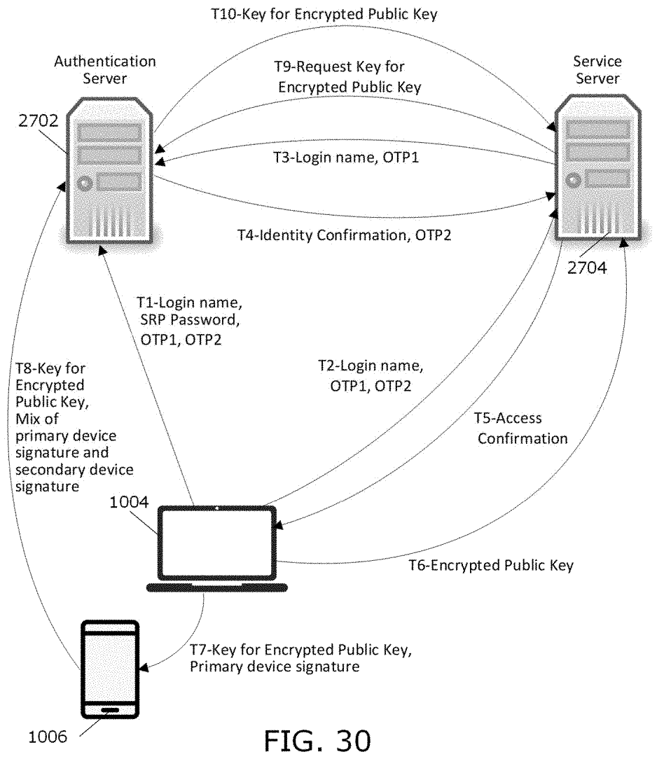

FIG. 30 depicts another embodiment utilizing a primary device 1004 and a secondary device 1006 to avert man-in-the-middle attacks, wherein a signature from each device, advantageously registered at an authentication server in a registration phase, enables multi-factor authentication. At time T1, the client's primary device 1004 sends a login name, a password using Secure Remote Password (SRP) protocol, OTP1, and OTP2 to an authentication server 2702. At time T2, the client's primary device 1004 sends the login name, OTP1, and OTP2 to a service server 2704, such as a Virtual Private Network (VPN) server. At time T3, service server 2704 sends the login name and OTP1 to the authentication server 2702. At time T4, confirmation of identity and OTP2 are provided from the authentication server 2702 to the service server 2704. At time T5, confirmation of access is provided from the service server 2704 to the client's primary device 1004. At time T6, the client's primary device 1004 sends the encrypted public key to the service server 2704. At time T7, the client's primary device 1004 sends the key for the encrypted public key and a primary device 1004 signature to the client's secondary device 1006. At time T8, the client's secondary device 1006 sends the key for the encrypted public key and a mix of the primary device 1004 signature and the secondary device 1006 signature to the authentication server 2702. At time T9, the service server 2704 requests the key for the encrypted public key from the authentication server 2702. At time T10, the authentication server 2702 sends the key for the encrypted public key to the service server 2704.

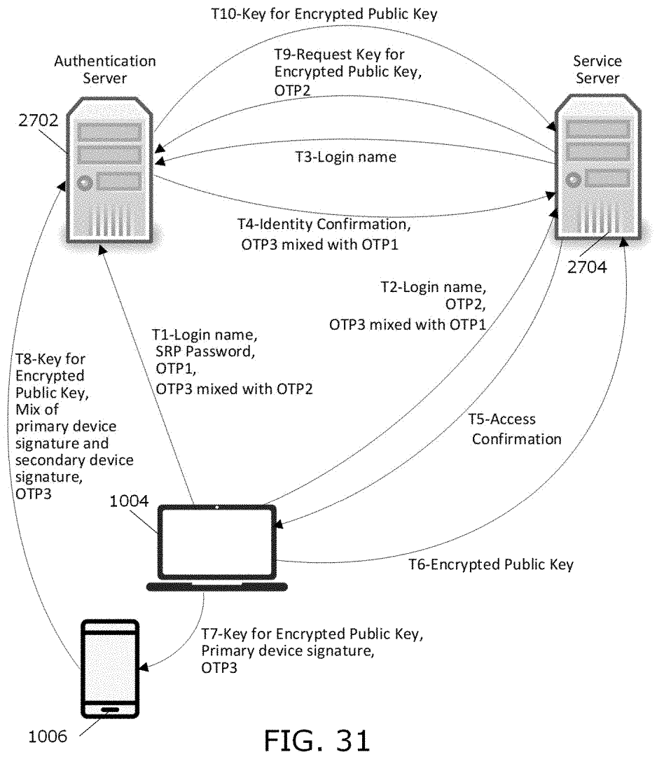

FIG. 31 depicts another embodiment utilizing a primary device 1004 and a secondary device 1006 to avert man-in-the-middle attacks, wherein a signature from each device, advantageously registered at an authentication server in a registration phase, enables multi-factor authentication. At time T1, the client's primary device 1004 sends a login name, a password using Secure Remote Password (SRP) protocol, OTP1, and OTP3 mixed with OTP2 to an authentication server 2702. At time T2, the client's primary device 1004 sends the login name, OTP2, and OTP3 mixed with OTP1 to a service server 2704, such as a Virtual Private Network (VPN) server. At time T3, service server 2704 sends the login name to the authentication server 2702. At time T4, confirmation of identity and OTP3 mixed with OTP1 are provided from the authentication server 2702 to the service server 2704. At time T5, confirmation of access is provided from the service server 2704 to the client's primary device 1004. At time T6, the client's primary device 1004 sends the encrypted public key to the service server 2704. At time T7, the client's primary device 1004 sends the key for the encrypted public key, a primary device 1004 signature, and OTP3 to the client's secondary device 1006. At time T8, the client's secondary device 1006 sends the key for the encrypted public key, a mix of the primary device 1004 signature and the secondary device 1006 signature, and OTP3 to the authentication server 2702. At time T9, the service server 2704 requests the key for the encrypted public key from the authentication server 2702 and sends OTP2 to the authentication server 2702. At time T10, the authentication server 2702 sends the key for the encrypted public key to the service server 2704.

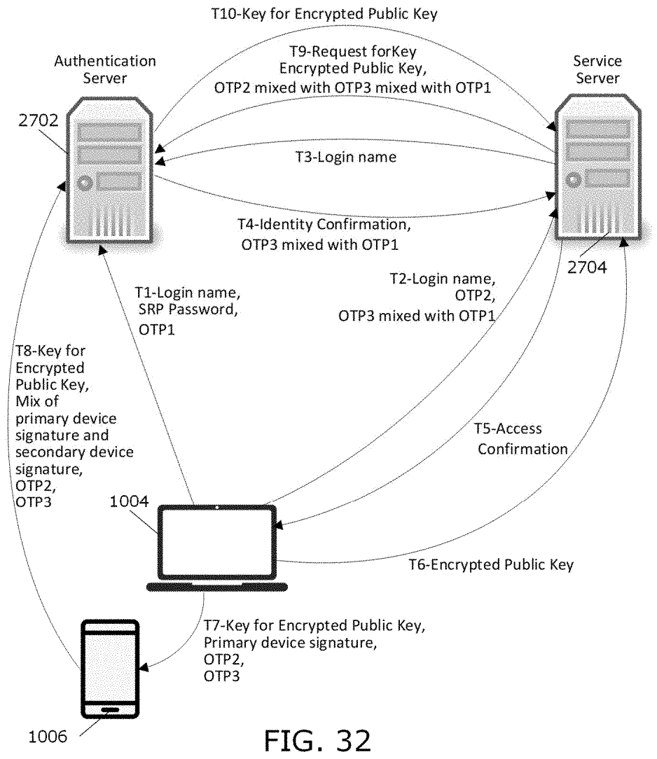

FIG. 32 depicts another embodiment utilizing a primary device 1004 and a secondary device 1006 to avert man-in-the-middle attacks, wherein a signature from each device, advantageously registered at an authentication server in a registration phase, enables multi-factor authentication. At time T1, the the client's primary device 1004 sends a login name, a password using Secure Remote Password (SRP) protocol, and OTP1 to an authentication server 2702. At time T2, the client's primary device 1004 sends the login name, OTP2, and OTP3 mixed with OTP1 to a service server 2704, such as a Virtual Private Network (VPN) server. At time T3, service server 2704 sends the login name to the authentication server 2702. At time T4, confirmation of identity and OTP3 mixed with OTP1 are provided from the authentication server 2702 to the service server 2704. At time T5, confirmation of access is provided from the service server 2704 to the client's primary device 1004. At time T6, the client's primary device 1004 sends the encrypted public key to the service server 2704. At time T7, the client's primary device 1004 sends the key for the encrypted public key, a primary device 1004 signature, OTP2, and OTP3 to the client's secondary device 1006. At time T8, the client's secondary device 1006 sends the key for the encrypted public key, a mix of the primary device 1004 signature and the secondary device 1006 signature, OTP2, and OTP3 to the authentication server 2702. At time T9, the service server 2704 requests the key for the encrypted public key from the authentication server 2702 and sends OTP2 mixed with OTP3 mixed with OTP1 to the authentication server 2702. At time T10, the authentication server 2702 sends the key for the encrypted public key to the service server 2704.

FIG. 33 depicts an embodiment directed to reducing traffic in a video chat by forwarding audio/video 1002 of a subset of attendees who are speaking. Adequate delay 1004, for example, in the range of 10 to 100 milliseconds, is introduced in the audio/video path to allow enough time to generate mute/unmute control instructions for a mute/unmute switch 1006 that directs audio/video to a video bridge. Audio is routed to an audio/video process 1008 that provides audio processing for VAD, volume and speaker identification, and video processing for lip movement detection.

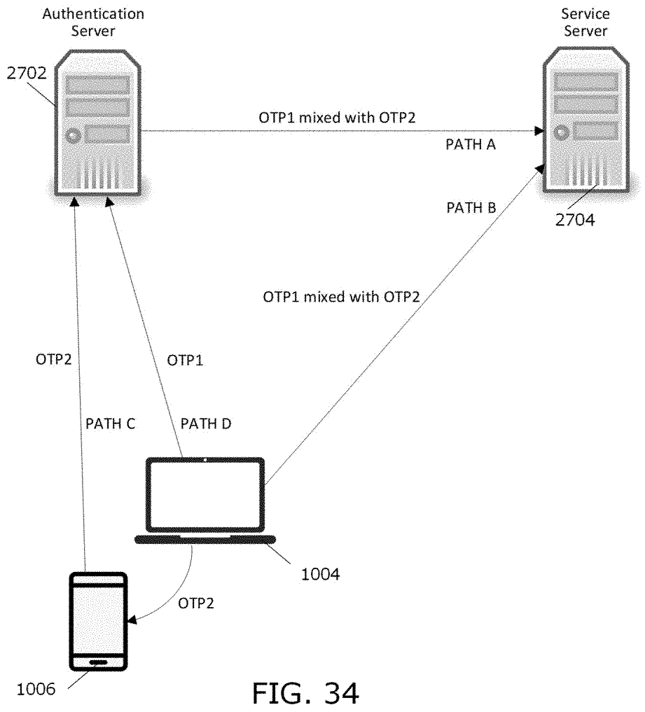

FIG. 34 depicts an example for an embodiment for sending a One-Time Password (OTP) to different nodes to be used in confirming each other's identity. This example utilizes a service server 2702 to verify the authenticity of the authentication server 2702. The client's primary device 1004 sends OTP1 to the authentication server 2702 and sends OTP2 to the client's secondary device 1006. The client's primary device 1004 computes OTP1 mixed with OTP2 and sends the result to the service server 2704 via PATH B. The client's secondary device 1006 sends OTP2 to the authentication server 2702. The authentication server 2702 computes OTP1 mixed with OTP2 and sends the result to the service server 2704 via PATH A. The service server 2704 compares OTP1 mixed with OTP2 received via PATH A and OTP1 mixed with OTP2 received via PATH B, and if the two are the same, the identity of the authentication server 2702 is verified by the service server 2704. By transmitting OPT1 and OPT2 through two different paths, PATH C and PATH D, and OPT1 mixed with OPT2 through a yet another path, PATH A or PATH B, any possible eavesdropper must gain access to PATH B or to both PATH C and PATH D to be successful. In addition, by utilizing distributed transmission of OTPs, the authenticity of PATH C and PATH D is verified by the service server 2702 at the same time that the authenticity of the authentication server 2702 is verified.

A method for sharing a secret, to be subsequently used as an encryption key in a symmetric encryption algorithm, between a master node and a slave node, including a probabilistic encryption algorithm and a probabilistic decryption algorithm; the master node's public key includes the generator matrix of a linear block code expressed as Ĝ=SGP; S is an invertible matrix, G is the generator matrix of a linear code randomized by the mater node relying on the outcomes of a probabilistic experiment E conducted in secret by the master node, and P is a permutation matrix, and in addition to Ĝ, a public key of the master node includes the block length of the linear code, A, the number of errors, t′, that the slave node should insert in each encrypted message, and the number of encrypted messages t″; slave nodes generate t″ encrypted messages of the form, \hat{x}ᵢ=xᵢĜ⊕eᵢ, i=1, . . . , t″, xᵢ, i=1, . . . , t″ are information vectors equipped with an error detection mechanism, e₁, i=1, . . . , t″ are error vectors; \hat{x}ᵢ, i=1, . . . , t″, are transmitted from the slave node to the master node; the master node, knowing the outcome of random experiment E, performs error correction on each \hat{x}ᵢ, i=1, . . . , t″; master node relies on the built-in error detection mechanism to identify \hat{x}ᵢ's that have resulted in error-free decrypted messages; master node extracts original encrypted messages xᵢ corresponding to error-free decrypted messages; if there are no error free decrypted messages, the master node signals the slave node to repeat the procedure starting from step 1.2 above; if there is a single error free decrypted message, the master node signals its index to the slave node and the corresponding xᵢ will be used as the final encryption key for the symmetric encryption algorithm; and if there are multiple error free decrypted messages, master node signals their indices to the slave node and the corresponding xis will be mixed at the master node and at the slave node and the outcome will be used as the final encryption key for the symmetric encryption algorithm. The method may further include generator matrix G constructed by concatenating linear codes selected with equal probability from a family of linear component codes {Cᵢ, i=1, . . . , N}, and wherein, result of experiment E determines the sequence of component codes forming G. The method may further include component codes {Cᵢ, i=1, . . . , N} that are repetition codes of different lengths, each length being an odd integer, and wherein, error detection is built-in by counting the number of erroneous symbols detected in the process of error correction at the master node and detecting error if the count is less than t′. The method may further include, wherein N=2, with family of linear component codes including two repetition codes of lengths 3 and 5 and experiment E being flipping of a fair coin, with outcomes selecting one of two linear component codes in a sequence of concatenating linear component codes. The method may further include a public key generator matrix obtained by computing Ĝ=S\check{G}P, wherein \check{G} is computed by first finding generator matrix G based on outcomes of a random experiment E, and then selecting an auxiliary linear code Ĉ composed of code-words Ĉ={cₖ, k=1, . . . , K}; conducting a random experiment Ê to select, corresponding to each row of matrix G, an element from Ĉ with probability 1/K, i.e., with equal probability for elements of Ĉ, to be added to corresponding row of G; and master node attempts error correction by exhaustively going through different code-words of Ĉ={cₖ, k=1, . . . , K}, removing contribution of cₖ, k=1, . . . , K as an additive term in \hat{x}ᵢ, and conducting error correction procedure in search for eᵢ, i=1, . . . , t″, and finding indices which have resulted in successful error correction, i.e., successful decryption, and sending the corresponding indices to the slave node to be used in generating the symmetric encryption key through mixing, or, signaling the slave node to repeat the process in case there are no successful decryption attempt. The method may further include a public key generator matrix obtained by computing Ĝ=S\check{G}P, wherein \check{G} is computed by first finding generator matrix G based on outcomes of random experiment E, and then selecting an auxiliary linear code Ĉ composed of code-words Ĉ={cₖ, k=1, . . . , K}, and then conducting a random experiment Ê to select, corresponding to each row of matrix G, an element from Ĉ with probability 1/K, i.e., with equal probability for elements of Ĉ, to be added to corresponding row of G, and wherein master node attempts error correction by exhaustively going through different code-words of Ĉ={cₖ, k=1, . . . , K}, removing contribution of cₖ, k=1, . . . , K as an additive term in \hat{x}ᵢ, then conducting error correction procedure in search for eᵢ, i=1, . . . , t″, and finding indices which have resulted in successful error correction, i.e., successful decryption, and sending the corresponding indices to the slave node to be used in generating the symmetric encryption key through mixing, or, signaling the slave node to repeat the process in case there are no successful decryption attempt.

A method for sharing a secret, to be subsequently used as an encryption key in a symmetric encryption algorithm, between a master node and a slave node, including a probabilistic encryption algorithm and a probabilistic decryption algorithm, wherein the master node's public key includes the generator matrix of a linear block code expressed as G=S₁G₁P₁S₂G₂P₂ . . . S_{q}G_{q}P_{q}, wherein G₁, . . . , G_{g} are generator matrices of linear codes constructed by conducting some random experiments at the master node, P₁, . . . , P_{q} are permutation matrices, and S₁, . . . , S_{q} are invertible matrices, and, in addition to G, public key of the master node includes the block length of the linear code, n, the number of errors, t′, that the slave node should insert in each encrypted message, and the number of encrypted messages t″, wherein the slave nodes generate t″ encrypted messages of the form, \hat{x}ᵢ=xᵢG⊕eᵢ, i=1, . . . , t″, wherein xᵢ, i=1, . . . , t″ are information vectors equipped with an error detection mechanism, eᵢ, i=1, . . . , t″ are error vectors, and wherein \hat{x}ᵢ, i=1, . . . , t″, are transmitted from the slave node to the master node, and wherein master node, knowing specific outcomes of random experiments, performs error correction on each \hat{x}ᵢ, i=1, . . . , t″, and wherein master node relies on the built-in error detection mechanism to identify \hat{x}ᵢ that have resulted in an error-free decrypted messages; master node extracts original encrypted messages xᵢ corresponding to error-free decrypted messages; if there are no error free decrypted messages, master node signals the slave node to repeat the procedure starting from step 7.2 above, and if there is a single error free decrypted message, master node signals its index to the slave node and the corresponding xᵢ will be used as the final encryption key for the symmetric encryption algorithm, and if there are multiple error free decrypted messages, master node signals their indices to the slave node and the corresponding xᵢ's will be mixed at the master node and at the slave node and the result will be used as the final encryption key for the symmetric encryption algorithm. G₁, . . . , G_{q} may be generator matrices of repetition codes, and wherein, an iterative message passing algorithm is used for error correction. G₁, . . . , G_{q} are generator matrices of low density parity check codes, and wherein, an iterative message passing algorithm is used for error correction.

A method for distributing a binary encryption key, K, between a master node M, called “key keeper” hereafter, and multiple slave nodes, Sᵢ, i=1, . . . , P, wherein, the method is deployed between the master node and each slave node, Sᵢ, i=1, . . . , P, to generate a set of binary encryption keys Eᵢ, i=1, . . . , P, between the master node and each slave node Sᵢ, i=1, . . . , P, where Eᵢ has the same length as K, and wherein the master node transmits K⊕Eᵢ, where K⊕Eᵢ denotes bitwise XOR of binary vectors K and Eᵢ, to slave node Sᵢ, which in turns computes K⊕Eᵢ⊕Eᵢ and recovers K at Sᵢ. All binary encryption keys Eᵢ, i=1, . . . , P, may be produced using the same public key. Tasks of generating binary encryption keys Eᵢ, i=1, . . . , P, may be divided among multiple independent public keys. The slave nodes may send a key request to the master node for receiving a copy of the encryption key, K, and wherein, the master node forms a queue for “key requests” received from slave nodes, and the master node admits at most Qₘₐₓ “key requests” is its queue, unless there are no other nodes with the key in which case master node admits any incoming request in its queue even if queue length exceeds Q_{max,} and the master node redirects any “key request” received when its queue is at maximum Qₘₐₓ to a slave node who has already received a copy of the encryption key, K, called “deputy key keeper” hereafter, and wherein, the deputy key keeper may also form a queue similar to that of the master node and redirect key requests to some other slave node who has already received a copy of the encryption key, K. A deputy key keeper, once at maximum permissible queue length, may redirect further key requests to randomly selected slave nodes without considering if such a selected slave node has already received a copy of the encryption key, K, and wherein a slave node who does not have a copy of the encryption key, K, i.e., is not yet a “deputy key keeper”, will, in a similar fashion, redirect the incoming key request to another slave node which is selected randomly without considering if the selected slave node has a copy of the encryption key, K, or not.

A method for establishing an encryption key between a Node A and a Node B through store and forward relay nodes C and D, wherein Node A generates a public/private key pair using method of claim 2, and Node A stores the generated private key on a secure folder within Node A's device, and Node A sends the generated public key to a database associated with Node B which is kept on a Node C, and acts as a store and forward relay between A and B, and Node C transmits the generated public key, including generator matrix Ĝ, to Node B when Node B is online, and Node B, upon receiving the generated public key from Node C, will use the generated public key to generate \hat{x}ᵢ=xᵢĜ⊕eᵢ, i=1, . . . , t″, and Node B sends \hat{x}ᵢ, i=1, . . . , t″ to a database associated with Node A which is kept on a Node D, and acts as a store and forward relay between B and A, and Node D transmits \hat{x}ᵢ, i=1, . . . , t″ to Node A when Node A is online, and Node A, upon receiving \hat{x}ᵢ, i=1, . . . , t″, uses its local copy of the generated private key to process \hat{x}ᵢ, i=1, . . . , t″ for the purpose of recovering xᵢ, i=1, . . . , t″, and if Node A succeeds in recovering xᵢ's, Node A mixes recovered xᵢ's to generate its local copy of an encryption key; Node A sends the indices of recovered xᵢ's to a database associated with Node B which is kept on the Node C; Node C transmits the indices of recovered xᵢ's to Node B when Node B is online; Node B mixes recovered xᵢ's to generate its local copy of the encryption key, and if Node A does not succeed in recovering any of the xᵢ's, Node A informs Node B, through Node C, that the procedure has been unsuccessful and shall be repeated.

A method for establishing an encryption key between a Node A and a Node B through store and forward relay nodes C and D, wherein Node A generates a public/private key pair using the method, and Node A stores the generated private key on a secure folder within Node A's device, and Node A sends the generated public key to a database associated with Node B which is kept on a Node C, and Node C transmits the generated public key, including generator matrix Ĝ, to Node B when Node B is online, and Node B, upon receiving the generated public key from Node C, will use the generated public key to generate \hat{x}ᵢxᵢĜ⊕eᵢ, i=1, . . . , t″, and Node B sends \hat{x}ᵢ, i=1, . . . , t″ to a database associated with Node A which is kept on a Node D, and Node D transmits \hat{x}ᵢ, i=1, . . . , t″ to Node A when Node A is online, and Node A, upon receiving \hat{x}ᵢ, i=1, . . . , t″, uses its local copy of the generated private key to process \hat{x}ᵢ, i=1, . . . , t″ for the purpose of recovering x₁, i=1, . . . , t″, and if Node A succeeds in recovering xᵢ's, Node A mixes recovered xᵢ's to generate its local copy of an encryption key; Node A sends the indices of recovered xᵢ's to a database associated with Node B which is kept on the Node C; Node C transmits the indices of recovered xᵢ's to Node B when Node B is online; Node B mixes recovered xᵢ's to generate its local copy of the encryption key, and if Node A does not succeed in recovering any of the xᵢ's, Node A informs Node B, through Node C, that the procedure has been unsuccessful and shall be repeated.

The master node, slave node, authentication server, and service server may be any type of computer, computing device, server, processor, or other electronic communication device able to communicate over wireless and/or wireline communication paths or channels, including through a communications network. The client devices and various nodes may be any type of communication device including but not limited to personal computers, laptops, smartphone, cellular phones, tablets, personal digital assistants, portable or handheld electronic devices, or other electronic communication devices able to communicate over wireless and/or wireline communication paths, links, or channels, over short and/or long distances, including directly and/or through one or more communications networks. The methods described in this disclosure may be implemented by instructions performed by one or more processors or computers. The instructions may be stored on a computer-readable storage medium, including non-transitory storage media.

A method comprises generating a random number at a first client device; sending, by the first client device, the random number mixed with a public key to a master node; conveying, by the first client device, random number recovery information and a signature associated with the public key to a second client device; mixing, by the second client device, the signature associated with the public key with an identification of the second client device, resulting in a mixture; sending, by the second client device, the mixture plus the information for recovering the random number to the master node; and generating, by the master node, the random number from the random number recovery information and combining the random number with the random number mixed with the public key to recover the public key.

The second client device may be advantageously registered at the master node. The master node may send a first confirmation message to the second client device. Responsive to receiving the first confirmation message, the second client device may send a second confirmation message to the first client device. Responsive to receiving the second confirmation message, the first client device may send a third confirmation message to the master node. The random number may be a binary vector of a same binary length as the public key. The random number recovery information may be a seed generated by the first client device, and the random number may be generated from the seed as input to a random number generator. The public key may be a key generator matrix. An alarm message may be sent to the first client device when expected data from the second client device does not arrive within a predetermined time period. Upon identifying a client associated with the first client device and the second client device, credentials of at least one of the first client device and the second client device may be added to facilitate future access by the at least one of the first client device and the second client device. At least one of the signature associated with the public key and the random number recovery information may be conveyed to the second client device via any of a Bluetooth connection, a universal serial bus connection, or quick response code. The mixture may facilitate authentication of the public key and authentication of the second client device.

An embodiment of a method performed by a server comprises receiving, over a first communication link, an encrypted asymmetric key from a client device; receiving, over a first communication link, an encrypted asymmetric key from a client device; receiving, over a second communication link, authentication key data from an auxiliary device associated with the client device; recovering the asymmetric key by decrypting the encrypted asymmetric key using the authentication key data; and using the decrypted asymmetric key to exchange a further encrypted message with the client device. Optionally, the method may further comprise: receiving, from a previously registered auxiliary device associated with the client device, over a second communication link, a mixture of a signature of the asymmetric key and a stored device identification of the previously registered auxiliary device; generating a local signature of the asymmetric key; mixing the local signature of the asymmetric key with a previously stored device identification of the previously registered auxiliary device to obtain a local mixture; and, when the local mixture and the received mixture match, authenticating the client device.

An embodiment of a method, performed by a server, includes receiving an encrypted asymmetric key from a client device over a first communication link, the encrypted asymmetric key being encrypted by an authentication key; receiving, from a previously registered auxiliary device associated with the client device, over a second communication link, (i) a mixture of a signature of the asymmetric key and a stored device identification of the previously registered auxiliary device and (ii) authentication key data; verifying the asymmetric key by decrypting the encrypted asymmetric key using the authentication key data; generating a local signature of the asymmetric key; mixing the local signature of the asymmetric key with a previously stored device identification of the previously registered auxiliary device to obtain a local mixture; comparing the local mixture with the received mixture; and, when the local mixture and the received mixture match, using the decrypted asymmetric key to exchange a further encrypted message with the client device.

An embodiment of a server comprises at least one processor and at least one memory having stored instructions operative, when executed by the at least one processor, to cause the apparatus to: receive an encrypted asymmetric key from a client device over a first communication link, the encrypted asymmetric key being encrypted by an authentication key; receive, from a previously registered auxiliary device associated with the client device, over a second communication link, (i) a mixture of a signature of the asymmetric key and a stored device identification of the previously registered auxiliary device and (ii) authentication key data; verify the asymmetric key by decrypting the encrypted asymmetric key using the authentication key data; generate a local signature of the asymmetric key; mix the local signature of the asymmetric key with a previously stored device identification of the previously registered auxiliary device to obtain a local mixture; compare the local mixture with the received mixture; when the local mixture and the received mixture match, use the decrypted asymmetric key to exchange a further encrypted message with the client device.

An embodiment of a non-transitory computer-readable storage medium having stored instructions that are operative, when executed by a processor, to cause the processor to: receive an encrypted asymmetric key from a client device over a first communication link, the encrypted asymmetric key being encrypted by an authentication key; receive, from a previously registered auxiliary device associated with the client device, over a second communication link, (i) a mixture of a signature of the asymmetric key and a stored device identification of the previously registered auxiliary device and (ii) authentication key data; verify the asymmetric key by decrypting the encrypted asymmetric key using the authentication key data; generate a local signature of the asymmetric key; mix the local signature of the asymmetric key with a previously stored device identification of the previously registered auxiliary device to obtain a local mixture; compare the local mixture with the received mixture; when the local mixture and the received mixture match, use the decrypted asymmetric key to exchange a further encrypted message with the client device.

The authentication key data and the signature of the asymmetric key may be conveyed to the previously registered auxiliary device from the client device. The server may recover the authentication key from the authentication key data and combine the authentication key with the encrypted asymmetric key to recover the asymmetric key. The server may send a first confirmation message to the previously registered auxiliary device. Responsive to receiving the first confirmation message, the previously registered auxiliary device may send a second confirmation message to the client device. Responsive to receiving the second confirmation message, the client device may send a third confirmation message to the server. the authentication key may be a binary vector of a same binary length as the asymmetric key. The asymmetric key may be a public key. The authentication key data may a seed generated by the client device, and the authentication key may be generated from the seed as input to a random number generator. The asymmetric key may be a key generator matrix. An alarm message may be sent to the client device when expected data from the previously registered auxiliary device does not arrive within a predetermined time period. Upon identifying a client associated with the client device and the previously registered auxiliary device, credentials of at least one of the client device and the previously registered auxiliary device may be added to facilitate future access by the at least one of the first client device and the second client device. At least one of the signature associated with the asymmetric key and the authentication key data may be conveyed to the previously registered auxiliary device via any of a Bluetooth connection, a universal serial bus connection, or quick response code. The mixture may facilitate authentication of the asymmetric key and authentication of the previously registered auxiliary device. The further encrypted message may be another key. The another key may be an AES 256 key.

The present disclosure may be embodied in other forms without departing from its spirit or essential characteristics. The described embodiments are to be considered as examples, and in all respects are merely illustrative and not restrictive.

What is claimed is:

1. A method performed by a server, the method comprising:
receiving an encrypted asymmetric key from a client device over a first communication link, the encrypted asymmetric key being encrypted by an authentication key;
receiving, from a previously registered auxiliary device associated with the client device, over a second communication link, (i) a mixture of a signature of the asymmetric key and a stored device identification of the previously registered auxiliary device and (ii) authentication key data;
verifying the asymmetric key by decrypting the encrypted asymmetric key using the authentication key data;
generating a local signature of the asymmetric key;
mixing the local signature of the asymmetric key with a previously stored device identification of the previously registered auxiliary device to obtain a local mixture;
comparing the local mixture with the received mixture;
when the local mixture and the received mixture match, using the decrypted asymmetric key to exchange a further encrypted message with the client device.

2. The method of claim 1, wherein the authentication key data and the signature of the asymmetric key are conveyed to the previously registered auxiliary device from the client device.

3. The method of claim 1, further comprising recovering, by the server, the authentication key from the authentication key data and combining the authentication key with the encrypted asymmetric key to recover the asymmetric key.

4. The method of claim 1, further comprising the server sending a first confirmation message to the previously registered auxiliary device.

5. The method of claim 4, further comprising, responsive to receiving the first confirmation message, sending, by the previously registered auxiliary device, a second confirmation message to the client device.

6. The method of claim 5, further comprising, responsive to receiving the second confirmation message, sending, by the client device, a third confirmation message to the server.

7. The method of claim 1, wherein the authentication key is a binary vector of a same binary length as the asymmetric key.

8. The method of claim 1, wherein the asymmetric key is a public key.

9. The method of claim 1, wherein the authentication key data is a seed generated by the client device, and the authentication key is generated from the seed as input to a random number generator.

10. The method of claim 1, wherein the asymmetric key is a key generator matrix.

11. The method of claim 1, further comprising sending an alarm message to the client device when expected data from the previously registered auxiliary device does not arrive within a predetermined time period.

12. The method of claim 1, wherein, upon identifying a client associated with the client device and the previously registered auxiliary device, adding credentials of at least one of the client device and the previously registered auxiliary device to facilitate future access by the at least one of the first client device and the second client device.

13. The method of claim 1, wherein at least one of the signature associated with the asymmetric key and the authentication key data are conveyed to the previously registered auxiliary device via any of a Bluetooth connection, a universal serial bus connection, or quick response code.

14. The method of claim 1, wherein the mixture facilitates authentication of the asymmetric key and authentication of the previously registered auxiliary device.

15. The method of claim 1, wherein the further encrypted message is another key.

16. The method of claim 15, wherein the another key is an AES 256 key.

17. A server comprising:
at least one processor; and
at least one memory having stored instructions operative, when executed by the at least one processor, to cause the apparatus to:
receive an encrypted asymmetric key from a client device over a first communication link, the encrypted asymmetric key being encrypted by an authentication key;
receive, from a previously registered auxiliary device associated with the client device, over a second communication link, (i) a mixture of a signature of the asymmetric key and a stored device identification of the previously registered auxiliary device and (ii) authentication key data;
verify the asymmetric key by decrypting the encrypted asymmetric key using the authentication key data;
generate a local signature of the asymmetric key;
mix the local signature of the asymmetric key with a previously stored device identification of the previously registered auxiliary device to obtain a local mixture;
compare the local mixture with the received mixture;
when the local mixture and the received mixture match, use the decrypted asymmetric key to exchange a further encrypted message with the client device.

18. A method performed by a server, the method comprising:
receiving, over a first communication link, an encrypted asymmetric key from a client device;
receiving, over a second communication link, authentication key data from an auxiliary device associated with the client device;
recovering the asymmetric key by decrypting the encrypted asymmetric key using the authentication key data;
using the decrypted asymmetric key to exchange a further encrypted message with the client device.

19. The method of claim 18, further comprising:
receiving, from a previously registered auxiliary device associated with the client device, over a second communication link, a mixture of a signature of the asymmetric key and a stored device identification of the previously registered auxiliary device;
generating a local signature of the asymmetric key;
mixing the local signature of the asymmetric key with a previously stored device identification of the previously registered auxiliary device to obtain a local mixture;
when the local mixture and the received mixture match, authenticating the client device.
